(19) United States
(12) Patent Application Publication
(10) Pub. No.: US 2025/0324974 A1
(43) Pub. Date: Oct. 23, 2025

(54) STORAGE STABILIZATION AGENT FOR STABILIZING AQUEOUS COMPOSITIONS, PROCESS FOR STABILIZING AND USES THEREOF

(71) Applicant: Omya International AG, Oftringen (CH)

(72) Inventors: Joachim GLAUBITZ, Murgenthal (CH); Klaus SÜTTERLIN, Buggingen (DE)

(73) Assignee: Omya International AG, Oftringen (CH)

(21) Appl. No.: 18/873,041

(22) PCT Filed: Jun. 15, 2023
(86) PCT No.: PCT/EP2023/066167

§ 371 Date: Dec. 9, 2024

(30) Foreign Application Priority Data
Jun. 15, 2022 (EP) 22179197.3
Mar. 27, 2023 (EP) 23164277.8

(51) Int. Cl. A01N 59/16; A01N 25/04; A01N 59/00; A01P 1/00

(52) U.S. Cl. CPC A01N 59/16; A01N 25/04; A01N 59/00; A01P 1/00

(57) ABSTRACT

The present invention relates to a storage stabilization agent for stabilizing an aqueous composition upon storage comprising at least two different water soluble or water dispersible ion sources selected from the group consisting of water soluble or water dispersible source of bismuth ions, water soluble or water dispersible source of magnesium ions, water soluble or water dispersible source of sodium ions, water soluble or water dispersible source of potassium ions and water soluble or water dispersible source of zinc ions. Furthermore, the present invention relates to an aqueous preparation comprising the storage stabilization agent, a process for stabilizing an aqueous preparation upon storage as well as the use of the storage stabilization agent for stabilizing the pH value of an aqueous preparation or preventing microorganisms as well as viruses and/or bacteriophages from growing or both.

The present invention relates to a storage stabilization agent for stabilizing an aqueous composition upon storage comprising at least two different water soluble or water dispersible ion sources selected from the group consisting of water soluble or water dispersible source of bismuth ions, water soluble or water dispersible source of magnesium ions, water soluble or water dispersible source of sodium ions, water soluble or water dispersible source of potassium ions and water soluble or water dispersible source of zinc ions. Furthermore, the present invention relates to an aqueous preparation comprising the storage stabilization agent, a process for stabilizing an aqueous preparation upon storage as well as the use of the storage stabilization agent for stabilizing the pH value of an aqueous preparation or preventing microorganisms, viruses and/or bacteriophages from growing or both.

### BACKGROUND

In practice, aqueous preparations and especially suspensions, emulsions, dispersions or slurries of water-insoluble solids such as minerals, fillers or pigments are used extensively in the paper, paint, rubber, and plastics industries as coatings, fillers, extenders and pigments for papermaking as well as aqueous lacquers and paints. For example, suspensions or slurries of calcium carbonate, talc or kaolin are used in the paper industry in large amounts as filler and/or as a component in the preparation of coated paper. Furthermore, such aqueous preparations are also used as additives in the concrete and agriculture industries. Typical aqueous preparations of water-insoluble solids are characterized in that they comprise water, a water-insoluble solid compound and optionally further additives, such as dispersing agents, in the form of a suspension, a slurry or dispersion with a water-insoluble solid content of 0.1 to 99.0 wt.-% based on the total weight of the preparation. A typical aqueous preparation is a White Mineral Dispersion (WMD) having a solids content of 45.0 to 78.0 wt.-%. Water-soluble polymers and copolymers which may be used as e.g. dispersant and/or grinding aid in such preparation are, for example, described in U.S. Pat. No. 5,278,248.

Other aqueous preparations that are often used as fibre formulation, food formulation, pharmaceutical formulation, cosmetic formulation, plastic formulation, plaster formulation, varnish formulation, or joint filler formulation, are in the form of aqueous solutions, suspensions, emulsions, dispersions or slurries and comprise organic compounds, for example, carbohydrates such as starch, sugar, cellulose, modified cellulose and cellulose based pulp, glycerol, hydrocarbons and mixtures thereof.

The aforementioned aqueous preparations are often stored, for example, in bottles, Tetra paks™, containers, big packs or tanks before shipping. Furthermore, the aforementioned aqueous preparations are also often stored after shipping to the retailers or end consumers. However, during storing there might be changes in the preparation properties such as changes in pH. Further changes that might occur are changes in the viscosity, discolorations or reductions in other quality parameters, which negatively affect the commercial value of the aforementioned aqueous preparations. Furthermore, during storage there might occur microbial growth in such aqueous preparations, which means that these aqueous preparations are subject to contamination by microorganisms such as fungi, yeasts, molds, protozoa and/or aerobic and anaerobic bacteria as well as viruses and/or bacteriophages. Such contamination by microorganisms as well as viruses and/or bacteriophages is, depending on the species, a risk to humans, animals and/or crops.

Therefore, the manufacturers of such aqueous preparations usually take measures for stabilising the suspensions, dispersions or slurries upon storage by using storage stabilizers, such as, for example, pH stabilizers and/or antimicrobial agents, since especially microbes can strongly affect the pH by lowering it. However, such known storage stabilizers often have risks for the environment and human or animal health in the quantities used.

In the art, several approaches for improving the storage stability or storage quality of aqueous preparations have been proposed. For example, CA2081831 A1 refers to a method of preventing the destabilization of an aqueous PCC slurry of precipitated calcium carbonate resulting in deleterious change in consistency thereof, wherein a stabilizing factor is added selected from the group consisting of hydroxy ethyl cellulose of wet and dry types, hydrophobically modified hydroxy ethyl cellulose of wet and dry types, alkali-soluble acrylic polymers, alkali swellable associate thickeners, attapulgite clays, alginates, salts of alginates, starches, hydroxypropyl methylcellulose, urethane associative stabilizers, hydroxybutyl methylcellulose, hydroxypropyl cellulose, guar and natural gum derivatives, carbon dioxide in gaseous form, and mixtures thereof. DE102016002221 A1 refers to a dispersion paint comprising 1 to 15 wt.-% pigment, 30 to 60 wt.-% filler, 1 to 25 wt.-% polymer, 0.1 to 3.5 wt.-% alkali metal alkylsiliconate, 25 to 70 wt.-% water, wherein the pH value of the dispersion paint is between 10 to 12. The pH value of the dispersion paint is stable for at least 4 weeks.

However, as already set out above it is on the one hand important that the aqueous preparations are stabilized for a defined amount of time against pH change but on the other hand it is also important that the aqueous preparations are stabilized against microorganisms as well as viruses and/or bacteriophages and prevent or reduce the growth and/or reproduction of microorganisms as well as viruses and/or bacteriophages.

In the art, several approaches for improving the microbiological quality of aqueous preparations have been proposed. For example, EP1139741 describes aqueous suspensions or dispersions of minerals, fillers and/or pigments, containing an agent in the form of a solution and derivatives of phenol in partially neutralized form. US20060111410 mentions a mixture comprising 1,2-benzisothiazolinone (BIT) and tetramethylol-acetylenediurea (TMAD) for protecting industrial materials and products against attack and destruction by microorganisms. Furthermore, it is suggested in the art to add formaldehyde-releasing substances to such aqueous preparations for improving the microbiological quality. For example, U.S. Pat. No. 4,655,815 mentions an antimicrobial composition comprising a formaldehyde donor. EP2374353 A1 refers to a process for preserving an aqueous preparation of mineral material like e.g. calcium carbonate preparations. EP2596702 A1 refers to a process for stabilising an aqueous mineral preparation comprising a step of adding at least one aldehyde-containing and/or aldehyde-releasing and/or phenolic and/or isothiazoline biocide to said aqueous mineral preparation. US20040168614 A1 relates to a paint and/or a coating composition including anti-corrosive pigment comprises a metal salt comprising a metal cation and an anion and a metal oxide or a metal hydroxide where the molar ratio of the total metal to the anion is in the range of 1:4 to 1:120.

Jon L. Hobman et al., “Bacterial antimicrobial metal ion resistance”, Journal of Medical Microbiology, 2014, 64, 471-497, discloses the use of metals such as mercury, arsenic, copper and silver as antimicrobial agents. EP1109562 B1 refers to composite particles that comprise a biocidally active oxidized metal in the core and a shell comprising a pyrithione salt of the core metal having complimentary biocidal activity to the activity of the core. The metal in the core may be selected from copper. However, also zinc, bismuth, silver or zirconium are mentioned. AU2001282982 discloses a coating composition for a surgical device comprising a therapeutic water-soluble glass and biocompatible polymer. The therapeutic water-soluble glass may contain an auxiliary antimicrobial agent, for example, silver. EP3627987 discloses antimicrobial compositions comprising at least one water soluble or water dispersible source of zinc ions in combination with at least one water soluble or water dispersible source of lithium ions. WO2017029482 A1 discloses compositions comprising an inorganic particulate mineral and an antimicrobial metal, wherein the antimicrobial metal is incorporated within the particles of the inorganic particulate mineral and herein the antimicrobial metal is selected from the group consisting of silver, cobalt, nickel, copper, iron, mercury, lead, zinc, zirconium, molybdenum, bismuth, gold, aluminium, magnesium, niobium, silicon, tantalum, hafnium, lanthanum, tungsten, calcium, titanium, vanadium, cerium, strontium, tin, lithium and combinations thereof. EP2982247 A1 relates to a process for preparing an antiseptic product, an antiseptic product obtainable by the process, an antiseptic inorganic powder composition, an antiseptic polymer product as well as the use of one or more source of lithium ions in combination with one or more source of sodium ions for the preparation of an antiseptic product being effective against microbial contamination.

However, the use of storage stabilization agents in aqueous preparations is subject to continuously increasing limitations. Especially in cases where the storage stabilizing agent prevents or reduces microbial growth there are continuously increasing limitations regarding their concentrations. However, at reduced antimicrobial concentrations the efficacy of the respective antimicrobials against bacteria, fungi, yeasts, algae and/or moulds is usually not satisfactory anymore in comparison to the antimicrobial efficacy observed at a higher concentration of the same antimicrobial, and thus, the obtained antimicrobial action at reduced antimicrobial concentration is typically insufficient for stabilising an aqueous preparation against microbial growth.

Furthermore, often these known antimicrobials do not stabilize the pH value of the aqueous preparation. Additionally, these antimicrobials are often toxic and/or hazardous to humans, animals and/or the environment.

Therefore, there is still a need in the art for storage stabilization agents that preserve aqueous preparations such as solutions, suspensions, dispersions and slurries against microorganisms as well as viruses and/or bacteriophages but avoiding, or at least reducing, the use of conventional antimicrobials such as phenols, halogenated phenols, halogen-containing compounds, halogen-releasing compounds, isothiazolinones, aldehyde-containing compounds, aldehyde-releasing compounds, guanidines, sulfones, thiocyanates, pyrithiones, antibiotics such as β-lactam antibiotics, quaternary ammonium salts, peroxides, perchlorates, amides, amines, heavy metals (other than zinc ions), biocidal enzymes, biocidal polypeptides, azoles, carbamates, glyphosates, sulphonamides and mixtures thereof. Alternatively, these storage stabilization agents should provide further beneficial properties and especially stabilize the pH of the aqueous composition.

Thus, it is an objective of the present invention to provide a storage stabilization agent for stabilizing an aqueous composition upon storage. In particular, it is an objective of the present invention to provide an storage stabilization agent which prevents or reduces microbial growth in aqueous preparations such as solutions, suspensions, dispersions and slurries. It is still a further object of the present invention to provide an storage stabilization agent which avoids, or at least reduces, the use of conventional antimicrobials such as phenols, halogenated phenols, halogen-containing compounds, halogen-releasing compounds, isothiazolinones, aldehyde-containing compounds, aldehyde-releasing compounds, guanidines, sulfones, thiocyanates, pyrithiones, antibiotics such as β-lactam antibiotics, quaternary ammonium salts, peroxides, perchlorates, amides, amines, biocidal enzymes, biocidal polypeptides, azoles, carbamates, glyphosates, sulphonamides and mixtures thereof. Another objective of the present invention is to provide a storage stabilization agent that stabilizes the pH of an aqueous composition or prevents microorganisms as well as viruses and/or bacteriophages from growing or both. Furthermore, it is another objective of the present invention that the storage stabilization agent is easy to handle, cheap, and is not toxic to humans, animals and/or the environment. Furthermore, the storage stabilization agent should be insensitive to decay by pH or temperature, and should be inert to chemical reactions.

### SUMMARY OF THE INVENTION

These and other objectives of the present invention can be solved by a storage stabilization agent, an aqueous preparation comprising the storage stabilization agent, a process and the uses as described in the present invention and defined in the claims.

According to one aspect of the present invention, a storage stabilization agent for stabilizing an aqueous composition upon storage is provided comprising at least two different water soluble or water dispersible ion sources selected from the group consisting of water soluble or water dispersible source of bismuth ions, water soluble or water dispersible source of magnesium ions, water soluble or water dispersible source of sodium ions, water soluble or water dispersible source of potassium ions and water soluble or water dispersible source of zinc ions.

The inventors surprisingly found that the inventive storage stabilization agent is able to stabilize an aqueous composition upon storage. More precisely, the storage stabilization agent stabilizes the aqueous composition for a defined amount of time against pH change or prevents microorganisms, viruses and/or bacteriophages from growing or both. Furthermore, in addition to the storage stabilization agent no further antimicrobials are necessary to prevent or reduce the growth and/or reproduction of microorganisms, viruses and/or bacteriophages. Furthermore, the inventive storage stabilization agent is easy to handle, cheap, and is not toxic to humans, animals and/or the environment. Furthermore, the storage stabilization agent is insensitive to decay by pH or temperature, and is inert to chemical reactions.

A second aspect of the present invention refers to an aqueous preparation, preferably a paper making formulation, a paper coating formulation, fibre formulation, food formulation, pharmaceutical formulation, cosmetic formulation, plastic formulation, plaster formulation, varnish formulation, joint filler formulation, adhesive formulation, metal working fluid, cooling fluid, primer coat, levelling compound, and/or a paint formulation, comprising the inventive storage stabilization agent.

A further aspect of the present invention refers to a process for stabilizing an aqueous preparation upon storage, said process comprising the steps of
a) providing an aqueous preparation, preferably a paper making formulation, a paper coating formulation, fibre formulation, food formulation, pharmaceutical formulation, cosmetic formulation, plastic formulation, plaster formulation, varnish formulation, joint filler formulation, adhesive formulation, metal working fluid, cooling fluid, primer coat, levelling compound, and/or a paint formulation,
b) providing a storage stabilization agent according to the present invention, and
c) contacting and mixing the aqueous preparation of step a) with the storage stabilization agent of step b) in any order for obtaining the stabilized aqueous preparation.

Another aspect of the present invention refers to the use of an storage stabilization agent according to the present invention for stabilizing the pH value of an aqueous preparation and/or for preserving the aqueous preparation against microorganisms, viruses and/or bacteriophages.

Preferred embodiments of the present invention are defined in the dependent claims.

According to one embodiment of the present invention, the water soluble or water dispersible source of bismuth ions is at least one bismuth salt, preferably the at least one bismuth salt is selected from the group consisting of bismuth carbonate, bismuth subcarbonate, bismuth oxide, bismuth hydroxide, bismuth chloride, bismuth iodide, bismuth phosphate, bismuth citrate, bismuth acetate, bismuth lactate, bismuth subsalicylate, polymeric salts of bismuth and mixtures thereof, said polymeric salt of bismuth is preferably selected from bismuth salts of acrylic homopolymers, acrylic copolymers such as copolymers of acrylic acid and maleic acid and/or acrylamide, polyphosphates and mixtures thereof.

According to another embodiment of the present invention, the water soluble or water dispersible source of magnesium ions is at least one magnesium salt, preferably the at least one magnesium salt is selected from the group consisting of magnesium carbonate, magnesium chloride, magnesium oxide, magnesium hydroxide, magnesium phosphate, magnesium citrate, magnesium maleate, magnesium acetate and magnesium lactate; polymeric salts of magnesium and mixtures thereof, said polymeric salt of magnesium is preferably selected from magnesium salts of acrylic homopolymers, acrylic copolymers such as copolymers of acrylic acid and maleic acid and/or acrylamide, polyphosphates and mixtures thereof.

According to another embodiment of the present invention, the water soluble or water dispersible source of sodium ions is at least one sodium salt, preferably the at least one sodium salt is selected from the group consisting of sodium carbonate, sodium chloride, sodium hydroxide, sodium phosphate, sodium citrate, sodium maleate, sodium acetate and sodium lactate; polymeric salts of sodium and mixtures thereof, said polymeric salt of sodium is preferably selected from sodium salts of acrylic homopolymers, acrylic copolymers such as copolymers of acrylic acid and maleic acid and/or acrylamide, polyphosphates and mixtures thereof.

The storage stabilization agent according to any one of the preceding claims, wherein the water soluble or water dispersible source of potassium ions is at least one potassium salt, preferably the at least one potassium salt is selected from the group consisting of potassium carbonate, potassium chloride, potassium hydroxide, potassium phosphate, potassium citrate, potassium maleate, potassium acetate and potassium lactate; polymeric salts of potassium and mixtures thereof, said polymeric salt of potassium is preferably selected from potassium salts of acrylic homopolymers, acrylic copolymers such as copolymers of acrylic acid and maleic acid and/or acrylamide, polyphosphates and mixtures thereof.

According to another embodiment of the present invention, the water soluble or water dispersible source of zinc ions is at least one zinc salt, more preferably the at least one zinc salt is selected from the group consisting of zinc carbonate, zinc oxide, zinc chloride, zinc hydroxide, zinc phosphate, zinc citrate, zinc maleate, zinc acetate and zinc lactate; polymeric salts of zinc and mixtures thereof, said polymeric salt of zinc is preferably selected from zinc salts of acrylic homopolymers, acrylic copolymers such as copolymers of acrylic acid and maleic acid and/or acrylamide, polyphosphates and mixtures thereof.

According to another embodiment of the present invention, the storage stabilization agent comprises water and preferably each of the water soluble or water dispersible sources of ions are present in the composition in an amount from 1000 to 10000 ppm, preferably in an amount from 1500 to 8000 ppm, even more preferably in an amount from 2000 to 7000 ppm, and most preferably in an amount from 2500 to 5000 ppm, calculated relative to the weight of water.

According to another embodiment of the present invention, the storage stabilization agent has a pH value in the range from 3 to 14, more preferably from 5 to 14, even more preferably from 7 to 14, even more preferably from 7.5 to 11.5, and most preferably from 8 to 11.

According to another embodiment of the present invention, the weight ratio of the at least two different water soluble or water dispersible ion sources is from 100:1 to 1:100, preferably from 10:1 to 1:10 and most preferably from 5:1 to 1:5.

According to another embodiment of the present invention, the storage stabilization agent is free of at least one water soluble or water dispersible source of lithium ions.

According to another embodiment of the present invention, the storage stabilization agent comprises further additives selected from the group consisting of dispersing agents, viscosity agents, thickeners, rheological additives and defoaming agents.

According to another embodiment of the present invention, the at least two different water soluble or water dispersible ion sources are (i) a water soluble or water dispersible source of bismuth ions in combination with a water soluble or water dispersible source of magnesium ions or a water soluble or water dispersible source of sodium ions or (ii) a water soluble or water dispersible source of sodium ions in combination with a water soluble or water dispersible source of zinc ions.

According to another embodiment of the present invention, the inventive storage stabilization agent is present in the aqueous preparation in an amount such that the pH value of the aqueous preparation is stabilized and the aqueous preparation is preserved against microorganisms, viruses and/or bacteriophages for at least 15 days, preferably for at least 20 days more preferably for at least 30 days, even more preferably at least 60 days and most preferably 90 days.

According to another embodiment of the present invention, the aqueous preparation further comprises (i) at least one inorganic particulate material, preferably the at least one inorganic particulate material is selected from the group consisting of natural ground calcium carbonate, precipitated calcium carbonate, surface-modified calcium carbonate, dolomite, kaolin, clay, barite, talcum, aluminium hydroxide, aluminium silicate, titanium dioxide, hydromagnesite, perlite, sepiolite, brucite and mixtures thereof, and most preferably the at least one inorganic particulate material is selected from the group consisting of natural ground calcium carbonate and/or precipitated calcium carbonate, and/or (ii) at least one organic material, preferably the at least one organic material is selected from the group consisting of carbohydrates such as starch, sugar, cellulose, modified cellulose and cellulose based pulp, glycerol, hydrocarbons and mixtures thereof.

According to another embodiment of the present invention, the aqueous preparation has (i) a pH value of from 3 to 14, more preferably from 5 to 14, even more preferably from 7 to 14, even more preferably from 7.5 to 11.5 and most preferably from 8 to 11, and/or (ii) a solids content of up to 85.0 wt.-%, preferably from 10.0 to 82.0 wt.-%, and more preferably from 20.0 to 80.0 wt.-%, based on the total weight of the aqueous preparation.

According to another embodiment of the present invention, the aqueous preparation is a paper making formulation, a paper coating formulation, fibre formulation, food formulation, pharmaceutical formulation, cosmetic formulation, plastic formulation, plaster formulation, varnish formulation, joint filler formulation, adhesive formulation, metal working fluid, cooling fluid, primer coat, levelling compound, and/or a paint formulation.

According to another embodiment of the present invention, the the microorganisms are selected from the group comprising at least one strain of bacteria, at least one strain of fungi, mold, yeast, algae and mixtures thereof.

It should be understood that for the purposes of the present invention, the following terms have the following meanings:

A storage stabilization agent in the meaning of the present invention is an agent that stabilizes an aqueous composition upon storage. By “stabilizing upon storage” it is meant that an aqueous composition is stabilized for a defined amount of time against pH change and/or against microorganisms, viruses and/or bacteriophages. More precisely, by stabilizing upon storage it is meant that an aqueous composition, stored motionless at 25° C., does not exhibit a change in the pH value of more than ±2, preferable not more than ±1 ph-unit and/or does prevent or reduce the growth and/or reproduction of microorganisms, viruses and/or bacteriophages for at least 15 days.

According to the present invention, the wording “prevents microbial growth” means that no significant growth of microorganisms such as at least one strain of bacteria, at least one strain of fungi, mold, yeast, algae and mixtures thereof as well as viruses and/or bacteriophages is observed in the aqueous preparation when the storage stabilization agent is present. This preferably does not lead to an increase of the cfu value in the treated aqueous preparation compared to the preparation immediately before treatment, more preferably to a decrease of the value to less than 100 cfu/1 ml or 1 g of the aqueous preparation and even more preferably to a decrease of the value to 80 to 100 1 ml or 1 g of the aqueous preparation using the bacterial count method described in the example section herein. It is appreciated that the final aqueous preparation, i.e. comprising the storage stabilization agent, is diluted by a factor of 10 and 100 μl of the diluted composition is then plated out in order to evaluate the microbial growth.

According to the present invention, the wording “reduce microbial growth” means that growth of microorganisms such as at least one strain of bacteria, at least one strain of fungi, mold, yeast, algae and mixtures thereof as well as viruses and/or bacteriophages is slower in the aqueous preparation when the storage stabilization agent is present. This preferably leads to a lower cfu value in the treated aqueous preparation compared to the preparation without the storage stabilization agent before treatment, more preferably to a value of less than 100 cfu/1 ml or 1 g of the aqueous preparation using the bacterial count method described in the example section herein. It is appreciated that the final aqueous preparation, i.e. comprising the storage stabilization agent, is diluted by a factor of 10 and 100 μl of the diluted composition is then plated out in order to evaluate the microbial growth.

The term “microorganisms” or “microbe” in the meaning of the present invention refers to organisms of microscopic size and especially to bacteria, fungi, mold, yeast, algae and mixtures thereof.

The term “virus” in the meaning of the present invention is a microscopic infectious agent that contains genetic material, either DNA or RNA, and must invade a host in order to multiply.

The term “bacteriophage”, also known as a “phage”, is a virus that infects and replicates within bacteria and archaea. Bacteriophages are composed of proteins that encapsulate a DNA or RNA genome, and may have different structures. Phages replicate within the bacterium following the injection of their genome into its cytoplasm.

For the purpose of the present application, “water-insoluble” or “water-dispersible” materials are defined as those which, when mixed with 100 ml of deionised water and filtered at 20° C. to recover the liquid filtrate, provide less than or equal to 0.1 g of recovered solid material following evaporation at 95 to 100° C. of 100 g of said liquid filtrate. “Water-soluble” materials are defined as materials leading to the recovery of greater than 0.1 g of solid material following evaporation at 95 to 100° C. of 100 g of said liquid filtrate. In order to assess whether a material is an insoluble or soluble material in the meaning of the present invention, the sample size is greater than 0.1 g, preferably 0.5 g or more.

For the purpose of the present invention, the term “viscosity” or “Brookfield viscosity” refers to Brookfield viscosity. The Brookfield viscosity is for this purpose measured by a Brookfield DV-II+ Pro viscometer at 25° C.±1° C. at 100 rpm using an appropriate spindle of the Brookfield RV-spindle set and is specified in mPa·s. Based on his technical knowledge, the skilled person will select a spindle from the Brookfield RV-spindle set which is suitable for the viscosity range to be measured. For example, for a viscosity range between 200 and 800 mPa·s the spindle number 3 may be used, for a viscosity range between 400 and 1 600 mPa·s the spindle number 4 may be used, for a viscosity range between 800 and 3 200 mPa·s the spindle number 5 may be used, for a viscosity range between 1 000 and 2 000 000 mPa·s the spindle number 6 may be used, and for a viscosity range between 4 000 and 8 000 000 mPa·s the spindle number 7 may be used.

For the purpose of the present invention, the “solids content” of a liquid composition is a measure of the amount of material remaining after all the solvent or water has been evaporated. If necessary, the “solids content” of a suspension given in wt.-% in the meaning of the present invention can be determined using a Moisture Analyzer HR73 from Mettler-Toledo (T=120° C., automatic switch off 3, standard drying) with a sample size of 5 to 20 g.

A “suspension” or “slurry” in the meaning of the present invention comprises undissolved solids and water, and optionally further additives, and usually contains large amounts of solids and, thus, is more viscous and can be of higher density than the liquid from which it is formed.

An “aqueous composition” in the meaning of the present invention refers to a composition comprising water. More precisely, the term “aqueous” composition refers to a system, wherein the liquid phase comprises, preferably consists of, water. However, said term does not exclude that the liquid phase of the aqueous composition comprises minor amounts of at least one water-miscible organic solvent, preferably selected from the group comprising methanol, ethanol, acetone, acetonitrile, tetrahydrofuran and mixtures thereof. If the aqueous composition comprises at least one water-miscible organic solvent, the liquid phase of the aqueous composition comprises the at least one water-miscible organic solvent in an amount of from 0.1 to 40.0 wt.-% preferably from 0.1 to 30.0 wt.-%, more preferably from 0.1 to 20.0 wt.-% and most preferably from 0.1 to 10.0 wt.-%, based on the total weight of the liquid phase of the aqueous composition. For example, the liquid phase of the aqueous composition consists of water.

A “salt” in the meaning of the present invention is a chemical compound consisting of an ionic assembly of cations (positively charged ions) and anions (negatively charged ions) so that the product is electrically neutral (without a net charge).

Where the term “comprising” is used in the present description and claims, it does not exclude other elements. For the purposes of the present invention, the term “consisting of” is considered to be a preferred embodiment of the term “comprising”. If hereinafter a group is defined to comprise at least a certain number of embodiments, this is also to be understood to disclose a group, which preferably consists only of these embodiments.

Terms like “obtainable” or “definable” and “obtained” or “defined” are used interchangeably. This, for example, means that, unless the context clearly dictates otherwise, the term “obtained” does not mean to indicate that, for example, an embodiment must be obtained by, for example, the sequence of steps following the term “obtained” though such a limited understanding is always included by the terms “obtained” or “defined” as a preferred embodiment.

Whenever the terms “including” or “having” are used, these terms are meant to be equivalent to “comprising” as defined hereinabove.

### DETAILED DESCRIPTION OF THE INVENTION

According to the present invention a storage stabilization agent for stabilizing an aqueous composition upon storage comprising at least two different water soluble or water dispersible ion sources selected from the group consisting of water soluble or water dispersible source of bismuth ions, water soluble or water dispersible source of magnesium ions, water soluble or water dispersible source of sodium ions, water soluble or water dispersible source of potassium ions and water soluble or water dispersible source of zinc ions is provided.

In the following preferred embodiments of the inventive storage stabilization agent will be set out in more detail. It is to be understood that these embodiments and details also apply to the inventive aqueous preparation and uses thereof as well as to the inventive process for stabilizing that aqueous preparation.

### The Storage Stabilization Agent

A storage stabilization agent for stabilizing an aqueous composition upon storage comprising at least two different water soluble or water dispersible ion sources selected from the group consisting of water soluble or water dispersible source of bismuth ions, water soluble or water dispersible source of magnesium ions, water soluble or water dispersible source of sodium ions, water soluble or water dispersible source of potassium ions and water soluble or water dispersible source of zinc ions is provided.

Thus, it is one requirement of the present storage stabilization agent that it comprises at least two different water soluble or water dispersible ion sources. “At least two different” in the meaning of the present invention means that two or more, for example, three or all four water soluble or water dispersible ion sources are present in the inventive storage stabilization agent. “Different” in the meaning of the present invention means that, if the storage stabilization agent comprises at least one water soluble or water dispersible source of bismuth ions as one water soluble or water dispersible ion source, the second water soluble or water dispersible ion source is selected from the group consisting of water soluble or water dispersible source of magnesium ions, water soluble or water dispersible source of sodium ions, water soluble or water dispersible source of potassium ions and water soluble or water dispersible source of zinc ion. Alternatively, if the storage stabilization agent comprises at least one water soluble or water dispersible source of magnesium ions as one water soluble or water dispersible ion source, the second water soluble or water dispersible ion source is selected from the group consisting of water soluble or water dispersible source of bismuth ions, water soluble or water dispersible source of sodium ions, water soluble or water dispersible source of potassium ions and water soluble or water dispersible source of zinc ions. Alternatively, if the storage stabilization agent comprises a water soluble or water dispersible source of sodium ions as one water soluble or water dispersible ion source, the second water soluble or water dispersible ion source is selected from the group consisting of water soluble or water dispersible source of bismuth ions, water soluble or water dispersible source of magnesium ions, water soluble or water dispersible source of potassium ions and water soluble or water dispersible source of zinc ions. Alternatively, if the storage stabilization agent comprises at least one water soluble or water dispersible source of zinc ions as one water soluble or water dispersible ion source, the second water soluble or water dispersible ion source is selected from the group consisting of water soluble or water dispersible source of bismuth ions, water soluble or water dispersible source of magnesium ions, water soluble or water dispersible source of potassium ions and water soluble or water dispersible source of sodium ions. Finally, if the storage stabilization agent comprises at least one water soluble or water dispersible source of potassium ions as one water soluble or water dispersible ion source, the second water soluble or water dispersible ion source is selected from the group consisting of water soluble or water dispersible source of bismuth ions, water soluble or water dispersible source of magnesium ions, water soluble or water dispersible source of zinc ions and water soluble or water dispersible source of sodium ions.

The term source of “at least one” water soluble or water dispersible source of bismuth ions in the meaning of the present invention means that the source comprises, preferably consists of, one or more water soluble or water dispersible source(s) of bismuth ions.

In one embodiment of the present invention, the water soluble or water dispersible source of bismuth ions comprises, preferably consists of, one water soluble or water dispersible source of bismuth ions. Alternatively, the water soluble or water dispersible source of bismuth ions comprises, preferably consists of, two or more water soluble or water dispersible sources of bismuth ions. For example, the water soluble or water dispersible source of bismuth ions comprises, preferably consists of, two or three water soluble or water dispersible sources of bismuth ions. Preferably, the water soluble or water dispersible source of bismuth ions comprises, preferably consists of, two or more water soluble or water dispersible sources of bismuth ions

It is appreciated that the at least one water soluble or water dispersible source of bismuth ions of the storage stabilization agent can be any material comprising, preferably consisting of, bismuth ions as cations.

The at least one source of bismuth ions is water soluble or water dispersible. The term “water-insoluble” or “water-dispersible” or “dispersible in water” in the meaning of the present invention refers to systems in which only a part of the source of bismuth ions forms a solution with water, i.e. only a part of the particles of the at least one source of bismuth ions are dissolved in the solvent. More precisely, when the at least one source of bismuth ions is mixed with 100 ml of deionised water and filtered at 20° C. to recover the liquid filtrate, the liquid filtrate provides less than or equal to 0.1 g of recovered solid material following evaporation at 95 to 100° C. of 100 g of said liquid filtrate. The term “water soluble” or “soluble in water” in the meaning of the present invention refers to systems in which the source of bismuth ions forms a solution with water, i.e. the particles of the at least one source of bismuth ions are dissolved in the solvent. More precisely, when the at least one source of bismuth ions is mixed with 100 ml of deionised water and filtered at 20° C. to recover the liquid filtrate the liquid filtrate provides more than 0.1 g of recovered solid material following evaporation at 95 to 100° C. of 100 g of said liquid filtrate. In order to assess whether a source of bismuth ions is an insoluble or soluble material in the meaning of the present invention, the sample size is greater than 0.1 g, preferably 0.5 g or more.

The term “source” of bismuth ions in the meaning of the present invention refers to a compound that comprises, preferably consists of, bismuth ions, i.e. bismuth cations.

In one embodiment of the present invention, the at least one water soluble or water dispersible source of bismuth ions is provided in the form of at least one bismuth salt. Preferably the anionic group of the at least one bismuth salt is selected from the group comprising carbonate, oxide, chloride, hydroxide, iodide, phosphate, citrate, acetate, lactate, salicylate and mixtures thereof. In particular, the at least one bismuth salt is selected from the group consisting of bismuth carbonate, bismuth subcarbonate, bismuth oxide, bismuth hydroxide, bismuth chloride, bismuth iodide, bismuth phosphate, bismuth citrate, bismuth acetate, bismuth lactate, bismuth subsalicylate, polymeric salts of bismuth and mixtures thereof.

According to a preferred embodiment, the at least one water soluble or water dispersible source of bismuth ions is preferably bismuth carbonate, bismuth oxide or bismuth hydroxide. Preferably, the at least one water soluble or water dispersible source of bismuth ions is bismuth oxide.

Additionally or alternatively, the at least one water soluble or water dispersible source of bismuth ions is present as a polymeric salt of bismuth, such as acrylic homopolymers, acrylic copolymers such as copolymers of acrylic acid and maleic acid and/or acrylamide, polyphosphates and mixtures thereof having multiple acidic sites which can be partially or totally neutralised with bismuth ions. The polymeric salt of bismuth is preferably bismuth polyacrylate.

The polymeric salt of bismuth is preferably partially or completely neutralized, preferably to a degree of 5.0 to 100.0%, preferably to a degree of 25.0 to 100.0% and most preferably to a degree of 75.0 to 100.0% using a neutralizing agent containing ions of bismuth and, optionally other alkali metals and/or alkaline earth metals. According to a preferred embodiment, the acidic sites of the polymeric salt of bismuth are neutralized using a neutralizing agent containing only bismuth. Neutralized polyacrylates and/or polymethacrylates with an average molecular weight of not more than 50 000, preferably with an average molecular weight in the range from 1 000 to 25 000 and more preferably in the range from 3 000 to 12 000 are especially suitable.

Such sources of bismuth ions are known to the skilled person and are commercially available, for example, from Sigma Aldrich under the trade name Bismuth(III) oxide, purum≥98.0% (KT), 95381.

The term source of “at least one” water soluble or water dispersible source of magnesium ions in the meaning of the present invention means that the source comprises, preferably consists of, one or more water soluble or water dispersible source(s) of magnesium ions.

In one embodiment of the present invention, the water soluble or water dispersible source of magnesium ions comprises, preferably consists of, one water soluble or water dispersible source of magnesium ions. Alternatively, the water soluble or water dispersible source of magnesium ions comprises, preferably consists of, two or more water soluble or water dispersible sources of magnesium ions. For example, the water soluble or water dispersible source of magnesium ions comprises, preferably consists of, two or three water soluble or water dispersible sources of magnesium ions. Preferably, the water soluble or water dispersible source of magnesium ions comprises, preferably consists of, two or more water soluble or water dispersible sources of magnesium ions.

It is appreciated that the at least one water soluble or water dispersible source of magnesium ions of the storage stabilization agent can be any material comprising, preferably consisting of, magnesium ions as cations.

The at least one source of magnesium ions is water soluble or water dispersible. The term “water-insoluble” or “water-dispersible” or “dispersible in water” in the meaning of the present invention refers to systems in which only a part of the source of magnesium ions forms a solution with water, i.e. only a part of the particles of the at least one source of magnesium ions are dissolved in the solvent. More precisely, when the at least one source of magnesium ions is mixed with 100 ml of deionised water and filtered at 20° C. to recover the liquid filtrate, the liquid filtrate provides less than or equal to 0.1 g of recovered solid material following evaporation at 95 to 100° C. of 100 g of said liquid filtrate. The term “water soluble” or “soluble in water” in the meaning of the present invention refers to systems in which the source of magnesium ions forms a solution with water, i.e. the particles of the at least one source of magnesium ions are dissolved in the solvent. More precisely, when the at least one source of magnesium ions is mixed with 100 ml of deionised water and filtered at 20° C. to recover the liquid filtrate the liquid filtrate provides more than 0.1 g of recovered solid material following evaporation at 95 to 100° C. of 100 g of said liquid filtrate. In order to assess whether a source of magnesium ions is an insoluble or soluble material in the meaning of the present invention, the sample size is greater than 0.1 g, preferably 0.5 g or more.

The term “source” of magnesium ions in the meaning of the present invention refers to a compound that comprises, preferably consists of, magnesium ions, i.e. magnesium cations.

In one embodiment of the present invention, the at least one water soluble or water dispersible source of magnesium ions is preferably provided in the form of at least one magnesium salt. Preferably the anionic group of the at least one magnesium salt is selected from the group comprising carbonate, chloride, oxide, hydroxide, phosphate, citrate, maleate, acetate, lactate and mixtures thereof. According to a preferred embodiment of the present invention, the at least one magnesium salt is selected from the group consisting of magnesium carbonate, magnesium chloride, magnesium oxide, magnesium hydroxide, magnesium phosphate, magnesium citrate, magnesium maleate, magnesium acetate and magnesium lactate; polymeric salts of magnesium and mixtures thereof.

According to a preferred embodiment of the present invention, the at least one water soluble or water dispersible source of magnesium ions is preferably magnesium carbonate.

Additionally or alternatively, the at least one water soluble or water dispersible source of magnesium ions is present as a polymeric salt of magnesium, such as acrylic homopolymers, acrylic copolymers such as copolymers of acrylic acid and maleic acid and/or acrylamide, polyphosphates and mixtures thereof having multiple acidic sites which can be partially or totally neutralised with magnesium ions. The polymeric salt of magnesium is preferably magnesium polyacrylate.

The polymeric salt of magnesium is preferably partially or completely neutralized, preferably to a degree of 5.0 to 100.0%, preferably to a degree of 25.0 to 100.0% and most preferably to a degree of 75.0 to 100.0% using a neutralizing agent containing ions of magnesium and, optionally other alkali metals and/or alkaline earth metals. In one embodiment, the acidic sites of the polymeric salt of magnesium are neutralized using a neutralizing agent containing only magnesium. Neutralized polyacrylates and/or polymethacrylates with an average molecular weight of not more than 50 000, preferably with an average molecular weight in the range from 1 000 to 25 000 and more preferably in the range from 3 000 to 12 000 are especially suitable.

Such sources of magnesium ions are known to the skilled person and are commercially available, for example, from Sigma Aldrich under the trade name Magnesiumcarbonat, tested according to Ph. Eur., heavy, 63032.

The term source of “at least one” water soluble or water dispersible source of sodium ions in the meaning of the present invention means that the source comprises, preferably consists of, one or more water soluble or water dispersible source(s) of sodium ions.

In one embodiment of the present invention, the water soluble or water dispersible source of sodium ions comprises, preferably consists of, one water soluble or water dispersible source of sodium ions. Alternatively, the water soluble or water dispersible source of sodium ions comprises, preferably consists of, two or more water soluble or water dispersible sources of sodium ions. For example, the water soluble or water dispersible source of sodium ions comprises, preferably consists of, two or three water soluble or water dispersible sources of sodium ions. Preferably, the water soluble or water dispersible source of sodium ions comprises, preferably consists of, two or more water soluble or water dispersible sources of sodium ions.

It is appreciated that the at least one water soluble or water dispersible source of sodium ions of the instant storage stabilization agent can be any material comprising, preferably consisting of, sodium ions as cations.

According to a preferred embodiment the at least one source of sodium ions is water soluble or water dispersible.

The at least one source of sodium ions is water soluble or water dispersible. The term “water-insoluble” or “water-dispersible” or “dispersible in water” in the meaning of the present invention refers to systems in which only a part of the source of sodium ions forms a solution with water, i.e. only a part of the particles of the at least one source of sodium ions are dissolved in the solvent. More precisely, when the at least one source of sodium ions is mixed with 100 ml of deionised water and filtered at 20° C. to recover the liquid filtrate, the liquid filtrate provides less than or equal to 0.1 g of recovered solid material following evaporation at 95 to 100° C. of 100 g of said liquid filtrate. The term “water soluble” or “soluble in water” in the meaning of the present invention refers to systems in which the source of sodium ions forms a solution with water, i.e. the particles of the at least one source of sodium ions are dissolved in the solvent. More precisely, when the at least one source of sodium ions is mixed with 100 ml of deionised water and filtered at 20° C. to recover the liquid filtrate the liquid filtrate provides more than 0.1 g of recovered solid material following evaporation at 95 to 100° C. of 100 g of said liquid filtrate. In order to assess whether a source of sodium ions is an insoluble or soluble material in the meaning of the present invention, the sample size is greater than 0.1 g, preferably 0.5 g or more.

The term “source” of sodium ions in the meaning of the present invention refers to a compound that comprises, preferably consists of, sodium ions, i.e. sodium cations.

In one embodiment of the present invention, the at least one water soluble or water dispersible source of sodium ions is preferably provided in the form of at least one sodium salt. Preferably the anionic group of the at least one sodium salt is selected from the group comprising carbonate, chloride, hydroxide, phosphate, citrate, maleate, acetate, lactate and mixtures thereof. In particular, the at least one sodium salt is selected from the group consisting of sodium carbonate, sodium chloride, sodium hydroxide, sodium phosphate, sodium citrate, sodium maleate, sodium acetate and sodium lactate, polymeric salts of sodium and mixtures thereof.

According to a preferred embodiment, the at least one water soluble or water dispersible source of sodium ions is preferably sodium carbonate.

Additionally or alternatively, the at least one water soluble or water dispersible source of sodium ions is present as a polymeric salt of sodium, such as acrylic homopolymers, acrylic copolymers such as copolymers of acrylic acid and maleic acid and/or acrylamide, polyphosphates and mixtures thereof having multiple acidic sites which can be partially or totally neutralised with sodium ions. The polymeric salt of sodium is preferably selected from Li₂Na₂polyphosphate, lithium-sodium hexamethaphosphate or sodium polyacrylate.

The polymeric salt of sodium is preferably partially or completely neutralized, preferably to a degree of 5.0 to 100.0%, preferably to a degree of 25.0 to 100.0% and most preferably to a degree of 75.0 to 100.0% using a neutralizing agent containing ions of sodium and, optionally other alkali metals and/or alkaline earth metals. In one embodiment, the acidic sites of the polymeric salt of sodium are neutralized using a neutralizing agent containing only sodium. Neutralized polyacrylates and/or polymethacrylates with an average molecular weight of not more than 50 000, preferably with an average molecular weight in the range from 1 000 to 25 000 and more preferably in the range from 3 000 to 12 000 are especially suitable.

Such sources of sodium ions are known to the skilled person and are commercially available, for example, from Sigma Aldrich under the trade name Natriumcarbonat, powder, 99.5%, ACS reagent, 223530.

The term source of “at least one” water soluble or water dispersible source of potassium ions in the meaning of the present invention means that the source comprises, preferably consists of, one or more water soluble or water dispersible source(s) of potassium ions.

In one embodiment of the present invention, the water soluble or water dispersible source of potassium ions comprises, preferably consists of, one water soluble or water dispersible source of potassium ions. Alternatively, the water soluble or water dispersible source of potassium ions comprises, preferably consists of, two or more water soluble or water dispersible sources of potassium ions. For example, the water soluble or water dispersible source of potassium ions comprises, preferably consists of, two or three water soluble or water dispersible sources of potassium ions. Preferably, the water soluble or water dispersible source of potassium ions comprises, preferably consists of, two or more water soluble or water dispersible sources of potassium ions.

It is appreciated that the at least one water soluble or water dispersible source of potassium ions of the instant storage stabilization agent can be any material comprising, preferably consisting of, potassium ions as cations.

According to a preferred embodiment the at least one source of potassium ions is water soluble or water dispersible.

The at least one source of potassium ions is water soluble or water dispersible. The term “water-insoluble” or “water-dispersible” or “dispersible in water” in the meaning of the present invention refers to systems in which only a part of the source of potassium ions forms a solution with water, i.e. only a part of the particles of the at least one source of potassium ions are dissolved in the solvent. More precisely, when the at least one source of potassium ions is mixed with 100 ml of deionised water and filtered at 20° C. to recover the liquid filtrate, the liquid filtrate provides less than or equal to 0.1 g of recovered solid material following evaporation at 95 to 100° C. of 100 g of said liquid filtrate. The term “water soluble” or “soluble in water” in the meaning of the present invention refers to systems in which the source of potassium ions forms a solution with water, i.e. the particles of the at least one source of potassium ions are dissolved in the solvent. More precisely, when the at least one source of potassium ions is mixed with 100 ml of deionised water and filtered at 20° C. to recover the liquid filtrate the liquid filtrate provides more than 0.1 g of recovered solid material following evaporation at 95 to 100° C. of 100 g of said liquid filtrate. In order to assess whether a source of potassium ions is an insoluble or soluble material in the meaning of the present invention, the sample size is greater than 0.1 g, preferably 0.5 g or more.

The term “source” of potassium ions in the meaning of the present invention refers to a compound that comprises, preferably consists of, potassium ions, i.e. potassium cations.

In one embodiment of the present invention, the at least one water soluble or water dispersible source of potassium ions is preferably provided in the form of at least one potassium salt. Preferably the anionic group of the at least one potassium salt is selected from the group comprising carbonate, chloride, hydroxide, phosphate, citrate, maleate, acetate, lactate and mixtures thereof. In particular, the at least one potassium salt is selected from the group consisting of potassium carbonate, potassium chloride, potassium hydroxide, potassium phosphate, potassium citrate, potassium maleate, potassium acetate and potassium lactate, polymeric salts of potassium and mixtures thereof.

According to a preferred embodiment, the at least one water soluble or water dispersible source of potassium ions is preferably potassium carbonate.

Additionally or alternatively, the at least one water soluble or water dispersible source of potassium ions is present as a polymeric salt of potassium, such as acrylic homopolymers, acrylic copolymers such as copolymers of acrylic acid and maleic acid and/or acrylamide, polyphosphates and mixtures thereof having multiple acidic sites which can be partially or totally neutralised with potassium ions.

The polymeric salt of potassium is preferably partially or completely neutralized, preferably to a degree of 5.0 to 100.0%, preferably to a degree of 25.0 to 100.0% and most preferably to a degree of 75.0 to 100.0% using a neutralizing agent containing ions of potassium and, optionally other alkali metals and/or alkaline earth metals. In one embodiment, the acidic sites of the polymeric salt of potassium are neutralized using a neutralizing agent containing only potassium. Neutralized polyacrylates and/or polymethacrylates with an average molecular weight of not more than 50 000, preferably with an average molecular weight in the range from 1 000 to 25 000 and more preferably in the range from 3 000 to 12 000 are especially suitable.

Such sources of potassium ions are known to the skilled person and are commercially available, for example, from Sigma Aldrich under the trade name Kaliumcarbonat, ACS reagent, ≥99.0%, 209619.

The term source of “at least one” water soluble or water dispersible source of zinc ions in the meaning of the present invention means that the source comprises, preferably consists of, one or more water soluble or water dispersible source(s) of zinc ions.

In one embodiment of the present invention, the water soluble or water dispersible source of zinc ions comprises, preferably consists of, one water soluble or water dispersible source of zinc ions. Alternatively, the water soluble or water dispersible source of zinc ions comprises, preferably consists of, two or more water soluble or water dispersible sources of zinc ions. For example, the water soluble or water dispersible source of zinc ions comprises, preferably consists of, two or three water soluble or water dispersible sources of zinc ions. Preferably, the water soluble or water dispersible source of zinc ions comprises, preferably consists of, two or more water soluble or water dispersible sources of zinc ions.

It is appreciated that the at least one water soluble or water dispersible source of zinc ions of the instant storage stabilization agent can be any material comprising, preferably consisting of, zinc ions as cations.

According to a preferred embodiment the at least one source of zinc ions is water soluble or water dispersible.

The at least one source of zinc ions is water soluble or water dispersible. The term “water-insoluble” or “water-dispersible” or “dispersible in water” in the meaning of the present invention refers to systems in which only a part of the source of zinc ions forms a solution with water, i.e. only a part of the particles of the at least one source of zinc ions are dissolved in the solvent. More precisely, when the at least one source of zinc ions is mixed with 100 ml of deionised water and filtered at 20° C. to recover the liquid filtrate, the liquid filtrate provides less than or equal to 0.1 g of recovered solid material following evaporation at 95 to 100° C. of 100 g of said liquid filtrate. The term “water soluble” or “soluble in water” in the meaning of the present invention refers to systems in which the source of zinc ions forms a solution with water, i.e. the particles of the at least one source of zinc ions are dissolved in the solvent. More precisely, when the at least one source of zinc ions is mixed with 100 ml of deionised water and filtered at 20° C. to recover the liquid filtrate the liquid filtrate provides more than 0.1 g of recovered solid material following evaporation at 95 to 100° C. of 100 g of said liquid filtrate. In order to assess whether a source of zinc ions is an insoluble or soluble material in the meaning of the present invention, the sample size is greater than 0.1 g, preferably 0.5 g or more.

The term “source” of zinc ions in the meaning of the present invention refers to a compound that comprises, preferably consists of, zinc ions, i.e. zinc cations.

In one embodiment of the present invention, the at least one water soluble or water dispersible source of zinc ions is preferably provided in the form of at least one zinc salt. Preferably the anionic group of the at least one zinc salt is selected from the group comprising carbonate, chloride, hydroxide, phosphate, citrate, maleate, acetate, lactate and mixtures thereof. In particular, the at least one zinc salt is selected from the group consisting of zinc carbonate, zinc oxide, zinc chloride, zinc hydroxide, zinc phosphate, zinc citrate, zinc maleate, zinc acetate and zinc lactate, polymeric salts of zinc and mixtures thereof.

According to a preferred embodiment, the at least one water soluble or water dispersible source of zinc ions is preferably zinc carbonate, zinc oxide or zinc hydroxide. Preferably, the at least one water soluble or water dispersible source of zinc ions is zinc oxide.

Additionally or alternatively, the at least one water soluble or water dispersible source of zinc ions is present as a polymeric salt of zinc, such as acrylic homopolymers, acrylic copolymers such as copolymers of acrylic acid and maleic acid and/or acrylamide, polyphosphates and mixtures thereof having multiple acidic sites which can be partially or totally neutralised with zinc ions. The polymeric salt of zinc is preferably selected from zinc polyacrylate.

The polymeric salt of zinc is preferably partially or completely neutralized, preferably to a degree of 5.0 to 100.0%, preferably to a degree of 25.0 to 100.0% and most preferably to a degree of 75.0 to 100.0% using a neutralizing agent containing ions of zinc and, optionally other alkali metals and/or alkaline earth metals. In one embodiment, the acidic sites of the polymeric salt of zinc are neutralized using a neutralizing agent containing only zinc. Neutralized polyacrylates and/or polymethacrylates with an average molecular weight of not more than 50 000, preferably with an average molecular weight in the range from 1 000 to 25 000 and more preferably in the range from 3 000 to 12 000 are especially suitable.

Such sources of zinc ions are known to the skilled person and are commercially available, for example, from Sigma Aldrich under the trade name Zinkoxid, puriss. P.a., ACS reagent, ≥99.0% (KT).

According to one embodiment of the present invention, the storage stabilization agent for stabilizing an aqueous composition upon storage comprises, preferably consists of two different water soluble or water dispersible ion sources selected from the group consisting of water soluble or water dispersible source of bismuth ions, water soluble or water dispersible source of magnesium ions, water soluble or water dispersible source of sodium ions, water soluble or water dispersible source of potassium ions and water soluble or water dispersible source of zinc ions.

For example, the storage stabilization agent for stabilizing an aqueous composition upon storage comprises, preferably consist of a water soluble or water dispersible source of bismuth ions in combination with a water soluble or water dispersible ion source selected from the group consisting of water soluble or water dispersible source of magnesium ions, water soluble or water dispersible source of sodium ions, water soluble or water dispersible source of potassium ions and water soluble or water dispersible source of zinc ions.

Alternatively, the storage stabilization agent for stabilizing an aqueous composition upon storage comprises, preferably consist of a water soluble or water dispersible source of magnesium ions in combination with a water soluble or water dispersible ion source selected from the group consisting of water soluble or water dispersible source of bismuth ions, water soluble or water dispersible source of sodium ions, water soluble or water dispersible source of potassium ions and water soluble or water dispersible source of zinc ions.

Alternatively, the storage stabilization agent for stabilizing an aqueous composition upon storage comprises, preferably consist of a water soluble or water dispersible source of sodium ions in combination with a water soluble or water dispersible ion source selected from the group consisting of water soluble or water dispersible source of bismuth ions, water soluble or water dispersible source of magnesium ions, water soluble or water dispersible source of potassium ions and water soluble or water dispersible source of zinc ions.

Alternatively, the storage stabilization agent for stabilizing an aqueous composition upon storage comprises, preferably consist of a water soluble or water dispersible source of zinc ions in combination with a water soluble or water dispersible ion source selected from the group consisting of water soluble or water dispersible source of bismuth ions, water soluble or water dispersible source of magnesium ions, water soluble or water dispersible source of potassium ions and water soluble or water dispersible source of sodium ions.

Alternatively, the storage stabilization agent for stabilizing an aqueous composition upon storage comprises, preferably consist of a water soluble or water dispersible source of potassium ions in combination with a water soluble or water dispersible ion source selected from the group consisting of water soluble or water dispersible source of bismuth ions, water soluble or water dispersible source of magnesium ions, water soluble or water dispersible source of zinc ions and water soluble or water dispersible source of sodium ions.

According to one embodiment, the storage stabilization agent for stabilizing an aqueous composition upon storage comprises, preferably consist of a water soluble or water dispersible source of bismuth ions in combination with a water soluble or water dispersible source of magnesium ions, or a water soluble or water dispersible source of bismuth ions in combination with a water soluble or water dispersible source of sodium ions, or a water soluble or water dispersible source of bismuth ions in combination with a water soluble or water dispersible source of zinc ions, or a water soluble or water dispersible source of magnesium ions in combination with a water soluble or water dispersible source of sodium ions, or a water soluble or water dispersible source of magnesium ions in combination with a water soluble or water dispersible source of zinc ions, or a water soluble or water dispersible source of sodium ions in combination with a water soluble or water dispersible source of zinc ions.

According to another embodiment of the present invention, the storage stabilization agent for stabilizing an aqueous composition upon storage comprises, preferably consists of three different water soluble or water dispersible ion sources selected from the group consisting of water soluble or water dispersible source of bismuth ions, water soluble or water dispersible source of magnesium ions, water soluble or water dispersible source of sodium ions, water soluble or water dispersible source of potassium ions and water soluble or water dispersible source of zinc ions.

For example, the storage stabilization agent for stabilizing an aqueous composition upon storage comprises, preferably consist of a water soluble or water dispersible source of bismuth ions and a water soluble or water dispersible source of magnesium ions in combination with a water soluble or water dispersible source of sodium ions.

Alternatively, the storage stabilization agent for stabilizing an aqueous composition upon storage comprises, preferably consist of a water soluble or water dispersible source of bismuth ions and a water soluble or water dispersible source of magnesium ions in combination with a water soluble or water dispersible source of zinc ions.

Alternatively, the storage stabilization agent for stabilizing an aqueous composition upon storage comprises, preferably consist of a water soluble or water dispersible source of bismuth ions and a water soluble or water dispersible source of sodium ions in combination with a water soluble or water dispersible source of zinc ions.

Alternatively, the storage stabilization agent for stabilizing an aqueous composition upon storage comprises, preferably consist of a water soluble or water dispersible source of magnesium ions and a water soluble or water dispersible source of sodium ions in combination with a water soluble or water dispersible source of zinc ions.

Alternatively, the storage stabilization agent for stabilizing an aqueous composition upon storage comprises, preferably consist of a water soluble or water dispersible source of bismuth ions and a water soluble or water dispersible source of magnesium ions in combination with a water soluble or water dispersible source of potassium ions.

Alternatively, the storage stabilization agent for stabilizing an aqueous composition upon storage comprises, preferably consist of a water soluble or water dispersible source of bismuth ions and a water soluble or water dispersible source of sodium ions in combination with a water soluble or water dispersible source of potassium ions.

Alternatively, the storage stabilization agent for stabilizing an aqueous composition upon storage comprises, preferably consist of a water soluble or water dispersible source of bismuth ions and a water soluble or water dispersible source of zinc ions in combination with a water soluble or water dispersible source of potassium ions.

Alternatively, the storage stabilization agent for stabilizing an aqueous composition upon storage comprises, preferably consist of a water soluble or water dispersible source of magnesium ions and a water soluble or water dispersible source of sodium ions in combination with a water soluble or water dispersible source of potassium ions.

Alternatively, the storage stabilization agent for stabilizing an aqueous composition upon storage comprises, preferably consist of a water soluble or water dispersible source of magnesium ions and a water soluble or water dispersible source of zinc ions in combination with a water soluble or water dispersible source of potassium ions.

Alternatively, the storage stabilization agent for stabilizing an aqueous composition upon storage comprises, preferably consist of a water soluble or water dispersible source of sodium ions and a water soluble or water dispersible source of zinc ions in combination with a water soluble or water dispersible source of potassium ions.

According to another embodiment of the present invention, the storage stabilization agent for stabilizing an aqueous composition upon storage comprises, preferably consists of four different water soluble or water dispersible ion sources selected from the group consisting of water soluble or water dispersible source of bismuth ions, water soluble or water dispersible source of magnesium ions, water soluble or water dispersible source of sodium ions, water soluble or water dispersible source of potassium ions and water soluble or water dispersible source of zinc ions. According to a preferred embodiment, the storage stabilization agent for stabilizing an aqueous composition upon storage comprises, preferably consists of a water soluble or water dispersible source of bismuth ions, a water soluble or water dispersible source of magnesium ions, a water soluble or water dispersible source of sodium ions and water soluble or water dispersible source of zinc ions.

According to another embodiment of the present invention, the storage stabilization agent for stabilizing an aqueous composition upon storage comprises, preferably consists of five different water soluble or water dispersible ion sources selected from the group consisting of water soluble or water dispersible source of bismuth ions, water soluble or water dispersible source of magnesium ions, water soluble or water dispersible source of sodium ions, water soluble or water dispersible source of potassium ions and water soluble or water dispersible source of zinc ions. More precisely, the storage stabilization agent for stabilizing an aqueous composition upon storage comprises, preferably consists of a water soluble or water dispersible source of bismuth ions, a water soluble or water dispersible source of magnesium ions, a water soluble or water dispersible source of sodium ions, a water soluble or water dispersible source of potassium ions and water soluble or water dispersible source of zinc ions.

According to a preferred embodiment of the present invention, the storage stabilization agent for stabilizing an aqueous composition upon storage comprises, preferably consists of at least two different water soluble or water dispersible ion sources, namely (i) a water soluble or water dispersible source of bismuth ions in combination with a water soluble or water dispersible source of magnesium ions or a water soluble or water dispersible source of sodium ions or (ii) a water soluble or water dispersible source of sodium ions in combination with a water soluble or water dispersible source of zinc ions.

According to a preferred embodiment of the present invention, the storage stabilization agent for stabilizing an aqueous composition upon storage comprises, preferably consists of at least two different water soluble or water dispersible ion sources, namely (i) a water soluble or water dispersible source of bismuth ions in combination with a water soluble or water dispersible source of magnesium ions or a water soluble or water dispersible source of sodium ions or (ii) a water soluble or water dispersible source of sodium ions in combination with a water soluble or water dispersible source of zinc ions.

According to a preferred embodiment of the present invention, the storage stabilization agent for stabilizing an aqueous composition upon storage comprises, preferably consists of at least two different water soluble or water dispersible ion sources, namely a water soluble or water dispersible source of bismuth ions, wherein the water soluble or water dispersible source of bismuth ions is at least one bismuth salt, preferably the at least one bismuth salt is selected from the group consisting of bismuth carbonate, bismuth subcarbonate, bismuth oxide, bismuth hydroxide, bismuth chloride, bismuth iodide, bismuth phosphate, bismuth citrate, bismuth acetate, bismuth lactate, bismuth subsalicylate, polymeric salts of bismuth and mixtures thereof, said polymeric salt of bismuth is preferably selected from bismuth salts of acrylic homopolymers, acrylic copolymers such as copolymers of acrylic acid and maleic acid and/or acrylamide, polyphosphates and mixtures thereof, in combination with a water soluble or water dispersible source of magnesium ions wherein the water soluble or water dispersible source of magnesium ions is at least one magnesium salt, preferably the at least one magnesium salt is selected from the group consisting of magnesium carbonate, magnesium chloride, magnesium oxide, magnesium hydroxide, magnesium phosphate, magnesium citrate, magnesium maleate, magnesium acetate and magnesium lactate; polymeric salts of magnesium and mixtures thereof, said polymeric salt of magnesium is preferably selected from magnesium salts of acrylic homopolymers, acrylic copolymers such as copolymers of acrylic acid and maleic acid and/or acrylamide, polyphosphates and mixtures thereof, or a water soluble or water dispersible source of sodium ions, wherein the water soluble or water dispersible source of sodium ions is at least one sodium salt, preferably the at least one sodium salt is selected from the group consisting of sodium carbonate, sodium chloride, sodium hydroxide, sodium phosphate, sodium citrate, sodium maleate, sodium acetate and sodium lactate; polymeric salts of sodium and mixtures thereof, said polymeric salt of sodium is preferably selected from sodium salts of acrylic homopolymers, acrylic copolymers such as copolymers of acrylic acid and maleic acid and/or acrylamide, polyphosphates and mixtures thereof. According to a preferred embodiment of the present invention, the storage stabilization agent for stabilizing an aqueous composition upon storage comprises, preferably consists of at least two different water soluble or water dispersible ion sources, namely a water soluble or water dispersible source of bismuth ions, preferably bismuth oxide in combination with a water soluble or water dispersible source of magnesium ions, preferably magnesium carbonate or a water soluble or water dispersible source of sodium ions, preferably sodium carbonate.

According to another preferred embodiment of the present invention, the storage stabilization agent for stabilizing an aqueous composition upon storage comprises, preferably consists of at least two different water soluble or water dispersible ion sources, namely a water soluble or water dispersible source of sodium ions, wherein the water soluble or water dispersible source of sodium ions is at least one sodium salt, preferably the at least one sodium salt is selected from the group consisting of sodium carbonate, sodium chloride, sodium hydroxide, sodium phosphate, sodium citrate, sodium maleate, sodium acetate and sodium lactate; polymeric salts of sodium and mixtures thereof, said polymeric salt of sodium is preferably selected from sodium salts of acrylic homopolymers, acrylic copolymers such as copolymers of acrylic acid and maleic acid and/or acrylamide, polyphosphates and mixtures thereof in combination with a water soluble or water dispersible source of zinc ions, wherein the water soluble or water dispersible source of zinc ions is at least one zinc salt, more preferably the at least one zinc salt is selected from the group consisting of zinc carbonate, zinc oxide, zinc chloride, zinc hydroxide, zinc phosphate, zinc citrate, zinc maleate, zinc acetate and zinc lactate; polymeric salts of zinc and mixtures thereof, said polymeric salt of zinc is preferably selected from zinc salts of acrylic homopolymers, acrylic copolymers such as copolymers of acrylic acid and maleic acid and/or acrylamide, polyphosphates and mixtures thereof. According to preferred embodiment of the present invention, the storage stabilization agent for stabilizing an aqueous composition upon storage comprises, preferably consists of at least two different water soluble or water dispersible ion sources, namely a water soluble or water dispersible source of sodium ions, preferably sodium carbonate in combination with a water soluble or water dispersible source of zinc ions, preferably zinc oxide.

According to one embodiment of the present invention, the storage stabilization agent for stabilizing an aqueous composition upon storage comprises, preferably consists of two different water soluble or water dispersible ion sources selected from the group consisting of water soluble or water dispersible source of bismuth ions, water soluble or water dispersible source of magnesium ions, water soluble or water dispersible source of sodium ions, water soluble or water dispersible source of potassium ions and water soluble or water dispersible source of zinc ions, with the proviso that if the first water soluble or water dispersible ion source is at least one water soluble or water dispersible source of magnesium ions or at least one water soluble or water dispersible source of zinc ions, than the second water soluble or water dispersible ion source is not sodium carbonate and/or sodium bicarbonate.

According to one embodiment of the present invention, the storage stabilization agent of the present invention is in solid form, preferably in form of a particulate material. The term “solid” according to the present invention refers to a material that is solid under standard ambient temperature and pressure (SATP) which refers to a temperature of 298.15 K (25° C.) and an absolute pressure of 1 bar. The solid may be in the form of a powder, tablet, granules, flakes etc.

According to another embodiment of the present invention, the storage stabilization agent is present in a liquid medium. Accordingly, the term “liquid medium” refers to a material that is liquid under standard ambient temperature and pressure (SATP) which refers to a temperature of 298.15 K (25° C.) and an absolute pressure of 1 bar. According to a preferred embodiment of the present invention, the storage stabilization agent comprises water and forms a solution or a dispersion or slurry.

The term “solution” in the meaning of the present invention refers to an storage stabilization agent dissolved in water in which no discrete solid particles are observed in the solvent, i.e. a solution with water is formed, wherein the water soluble or water dispersible source of bismuth ions and/or the water soluble or water dispersible source of magnesium ions and/or the water soluble or water dispersible source of sodium ions and/or the water soluble or water dispersible source of potassium ions and/or the water soluble or water dispersible source of zinc ions are dissolved in the water.

The term “dispersion” or “suspension” in the meaning of the present invention refers to an storage stabilization agent dissolved in water, wherein at least a part of the water soluble or water dispersible source of bismuth ions and/or the water soluble or water dispersible source of magnesium ions and/or the water soluble or water dispersible source of sodium ions and/or the water soluble or water dispersible source of potassium ions and/or the water soluble or water dispersible source of zinc ions are present as insoluble solids in the water.

In addition to the water further solvents may be present in the liquid phase. The solvents are water-miscible organic solvent, preferably selected from the group comprising methanol, ethanol, acetone, acetonitrile, tetrahydrofuran and mixtures thereof.

For example, the liquid phase comprises water and at least one water-miscible organic solvent in an amount of from 0.1 to 40.0 wt.-% preferably from 0.1 to 30.0 wt.-%, more preferably from 0.1 to 20.0 wt.-% and most preferably from 0.1 to 10.0 wt.-%, based on the total weight of the liquid phase. According to a preferred embodiment of the present invention the storage stabilization agent only consists of water as liquid phase and no further solvents.

In view of this, the storage stabilization agent can be in an undiluted, i.e. concentrated form. In another embodiment of the present invention, the storage stabilization agent is diluted to a suitable concentration. In the diluted form, the storage stabilization agent is preferably dissolved in water, wherein the corresponding diluted composition comprises preferably 0.001 to 20.0 wt.-% of the storage stabilization agent and most preferably 0.01 to 15 wt.-% of the storage stabilization agent, based on the total weight of the composition.

It is preferred that the storage stabilization agent is evenly distributed in the water and the optional organic solvent. However, in order to avoid an excessive dilution of the storage stabilization agent, it is preferred to keep the water content in the storage stabilization agent as low as possible or as low as necessary.

It is appreciated that each of the water soluble or water dispersible sources of ions, are present in the composition in an amount from 1000 to 10000 ppm, preferably in an amount from 1500 to 8000 ppm, even more preferably in an amount from 2000 to 7000 ppm, and most preferably in an amount from 2500 to 5000 ppm, calculated relative to the weight of water.

According to one embodiment of the present invention, the storage stabilization agent comprises water and preferably each of the at least one water soluble or water dispersible source of bismuth ions and/or the at least one water soluble or water dispersible source of magnesium ions and/or the at least one water soluble or water dispersible source of sodium ions and/or the at least one water soluble or water dispersible source of potassium ions and/or the at least one water soluble or water dispersible source of zinc ions are present in the composition in an amount from 1000 to 10000 ppm, preferably in an amount from 1500 to 8000 ppm, even more preferably in an amount from 2000 to 7000 ppm, and most preferably in an amount from 2500 to 5000 ppm, calculated relative to the weight of water.

That is to say, the storage stabilization agent preferably comprises water and:
a) at least one water soluble or water dispersible source of bismuth ions in an amount from 1000 to 10000 ppm, preferably in an amount from 1500 to 8000 ppm, even more preferably in an amount from 2000 to 7000 ppm, and most preferably in an amount from 2500 to 5000 ppm, calculated relative to the weight of water, and/or
b) at least one water soluble or water dispersible source of magnesium ions in an amount from 1000 to 10000 ppm, preferably in an amount from 1500 to 8000 ppm, even more preferably in an amount from 2000 to 7000 ppm, and most preferably in an amount from 2500 to 5000 ppm, calculated relative to the weight of water and/or
c) at least one water soluble or water dispersible source of sodium ions in an amount from 1000 to 10000 ppm, preferably in an amount from 1500 to 8000 ppm, even more preferably in an amount from 2000 to 7000 ppm, and most preferably in an amount from 2500 to 5000 ppm, calculated relative to the weight of water and/or
d) at least one water soluble or water dispersible source of potassium ions in an amount from 1000 to 10000 ppm, preferably in an amount from 1500 to 8000 ppm, even more preferably in an amount from 2000 to 7000 ppm, and most preferably in an amount from 2500 to 5000 ppm, calculated relative to the weight of water and/or
e) at least one water soluble or water dispersible source of zinc ions in an amount from 1000 to 10000 ppm, preferably in an amount from 1500 to 8000 ppm, even more preferably in an amount from 2000 to 7000 ppm, and most preferably in an amount from 2500 to 5000 ppm, calculated relative to the weight of water
with the proviso that at least two different water soluble or water dispersible ion sources are present.

According to another embodiment of the present invention, the storage stabilization agent preferably consists of water and:
a) at least one water soluble or water dispersible source of bismuth ions in an amount from 1000 to 10000 ppm, preferably in an amount from 1500 to 8000 ppm, even more preferably in an amount from 2000 to 7000 ppm, and most preferably in an amount from 2500 to 5000 ppm, calculated relative to the weight of water, and/or
b) at least one water soluble or water dispersible source of magnesium ions in an amount from 1000 to 10000 ppm, preferably in an amount from 1500 to 8000 ppm, even more preferably in an amount from 2000 to 7000 ppm, and most preferably in an amount from 2500 to 5000 ppm, calculated relative to the weight of water and/or
c) at least one water soluble or water dispersible source of sodium ions in an amount from 1000 to 10000 ppm, preferably in an amount from 1500 to 8000 ppm, even more preferably in an amount from 2000 to 7000 ppm, and most preferably in an amount from 2500 to 5000 ppm, calculated relative to the weight of water and/or
d) at least one water soluble or water dispersible source of potassium ions in an amount from 1000 to 10000 ppm, preferably in an amount from 1500 to 8000 ppm, even more preferably in an amount from 2000 to 7000 ppm, and most preferably in an amount from 2500 to 5000 ppm, calculated relative to the weight of water and/or
e) at least one water soluble or water dispersible source of zinc ions in an amount from 1000 to 10000 ppm, preferably in an amount from 1500 to 8000 ppm, even more preferably in an amount from 2000 to 7000 ppm, and most preferably in an amount from 2500 to 5000 ppm, calculated relative to the weight of water
with the proviso that at least two different water soluble or water dispersible ion sources are present.

It is appreciated that, if it is not indicated otherwise, the term “ppm” is calculated relative to the weight of water.

It is appreciated that the amount of each of the at least one water soluble or water dispersible source of bismuth ions, water soluble or water dispersible source of magnesium ions, water soluble or water dispersible source of sodium ions, water soluble or water dispersible source of potassium ions and water soluble or water dispersible source of zinc ions can vary in a great range in the storage stabilization agent.

In one preferred embodiment, the storage stabilization agent comprises preferably consist of water and at least one water soluble or water dispersible source of bismuth ions in an amount from 1000 to 10000 ppm in combination with a water soluble or water dispersible source of magnesium ions in an amount from 1000 to 10000 ppm, calculated relative to the weight of water.

In another embodiment, the storage stabilization agent comprises preferably consist of water and at least one water soluble or water dispersible source of bismuth ions in an amount from 1000 to 10000 ppm in combination with a water soluble or water dispersible source of sodium ions in an amount from 1000 to 10000 ppm, calculated relative to the weight of water.

In another embodiment, the storage stabilization agent comprises preferably consist of water and at least one water soluble or water dispersible source of sodium ions in an amount from 1000 to 10000 ppm in combination with a water soluble or water dispersible source of zinc ions in an amount from 1000 to 10000 ppm, calculated relative to the weight of water.

In another preferred embodiment, the storage stabilization agent comprises preferably consist of water and at least one water soluble or water dispersible source of bismuth ions in an amount from 2000 to 7000 ppm in combination with a water soluble or water dispersible source of magnesium ions in an amount from 2000 to 7000 ppm, calculated relative to the weight of water.

In another embodiment, the storage stabilization agent comprises preferably consist of water and at least one water soluble or water dispersible source of bismuth ions in an amount from 2000 to 7000 ppm in combination with a water soluble or water dispersible source of sodium ions in an amount from 2000 to 7000 ppm, calculated relative to the weight of water.

In another embodiment, the storage stabilization agent comprises preferably consist of water and at least one water soluble or water dispersible source of sodium ions in an amount from 2000 to 7000 ppm in combination with a water soluble or water dispersible source of zinc ions in an amount from 2000 to 7000 ppm, calculated relative to the weight of water.

In another preferred embodiment, the storage stabilization agent comprises preferably consist of water and at least one water soluble or water dispersible source of bismuth ions in an amount from 2500 to 5000 ppm in combination with a water soluble or water dispersible source of magnesium ions in an amount from 2500 to 5000 ppm, calculated relative to the weight of water.

In another embodiment, the storage stabilization agent comprises preferably consist of water and at least one water soluble or water dispersible source of bismuth ions in an amount from 2500 to 5000 ppm in combination with a water soluble or water dispersible source of sodium ions in an amount from 2500 to 5000 ppm, calculated relative to the weight of water.

In another embodiment, the storage stabilization agent comprises preferably consist of water and at least one water soluble or water dispersible source of sodium ions in an amount from 2500 to 5000 ppm in combination with a water soluble or water dispersible source of zinc ions in an amount from 2500 to 5000 ppm, calculated relative to the weight of water.

According to an exemplified embodiment, the storage stabilization agent comprises preferably consist of water and at least one water soluble or water dispersible source of sodium ions, for example sodium carbonate, in an amount of 8000 ppm in combination with a water soluble or water dispersible source of zinc ions, for example zinc oxide, in an amount of 2000 ppm, calculated relative to the weight of water. Alternatively, the storage stabilization agent comprises preferably consist of water and at least one water soluble or water dispersible source of sodium ions, for example sodium carbonate, in an amount of 7000 ppm in combination with a water soluble or water dispersible source of zinc ions, for example zinc oxide, in an amount of 1750 ppm, calculated relative to the weight of water. Alternatively, the storage stabilization agent comprises preferably consist of water and at least one water soluble or water dispersible source of sodium ions, for example sodium carbonate, in an amount of 6000 ppm in combination with a water soluble or water dispersible source of zinc ions, for example zinc oxide, in an amount of 1500 ppm, calculated relative to the weight of water. Alternatively, the storage stabilization agent comprises preferably consist of water and at least one water soluble or water dispersible source of sodium ions, for example sodium carbonate, in an amount of 5000 ppm in combination with a water soluble or water dispersible source of zinc ions, for example zinc oxide, in an amount of 1250 ppm, calculated relative to the weight of water. Alternatively, the storage stabilization agent comprises preferably consist of water and at least one water soluble or water dispersible source of sodium ions, for example sodium carbonate, in an amount of 4000 ppm in combination with a water soluble or water dispersible source of zinc ions, for example zinc oxide, in an amount of 1000 ppm, calculated relative to the weight of water.

According to another embodiment of the present invention the storage stabilization agent comprises water and preferably has a pH value in the range from 3 to 14, preferably from 5 to 14, even more preferably from 7 to 14, even more preferably from 7.5 to 11.5, and most preferably from 8 to 11.

The pH value is measured at 25° C. using a Mettler Toledo Seven Easy pH meter and a Mettler Toledo InLab Expert Pro pH electrode. A three point calibration (according to the segment method) of the instrument is first made using commercially available buffer solutions having pH values of 4, 7 and 10 at 25° C. (from Aldrich). The reported pH values are the endpoint values detected by the instrument (signal differs by less than 0.1 mV from the average over the last 6 seconds).

According to another preferred embodiment of the present invention, the weight ratio of the at least two different water soluble or water dispersible ion sources is from 100:1 to 1:100, preferably from 10:1 to 1:10 and most preferably from 5:1 to 1:5. For example, the weight ratio of the at least two different water soluble or water dispersible ion sources is from 4:1 to 1:4.

Additionally, or alternatively, the weight ratio of the at least one water soluble or water dispersible source of bismuth ions to the at least one water soluble or water dispersible source of sodium ions [Bi/Na] is from 100:1 to 1:100, preferably from 10:1 to 1:10 and most preferably from 5:1 to 1:5, for example from 4:1 to 1:4, or the weight ratio of the at least one water soluble or water dispersible source of bismuth ions to the at least one water soluble or water dispersible source of magnesium ions [Bi/Mg] is from 100:1 to 1:100, preferably from 10:1 to 1:10 and most preferably from 5:1 to 1:5, for example from 4:1 to 1:4, or the weight ratio of the at least one water soluble or water dispersible source of bismuth ions to the at least one water soluble or water dispersible source of zinc ions [Bi/Zn] is from 100:1 to 1:100, preferably from 10:1 to 1:10 and most preferably from 5:1 to 1:5, for example from 4:1 to 1:4, or the weight ratio of the at least one water soluble or water dispersible source of magnesium ions to the at least one water soluble or water dispersible source of sodium ions [Mg/Na] is from 100:1 to 1:100, preferably from 10:1 to 1:10 and most preferably from 5:1 to 1:5, for example from 4:1 to 1:4, or the weight ratio of the at least one water soluble or water dispersible source of magnesium ions to the at least one water soluble or water dispersible source of zinc ions [Mg/Zn] is from 100:1 to 1:100, preferably from 10:1 to 1:10 and most preferably from 5:1 to 1:5, for example from 4:1 to 1:4, or the weight ratio of the at least one water soluble or water dispersible source of sodium ions to the at least one water soluble or water dispersible source of zinc ions [Na/Zn] is from 100:1 to 1:100, preferably from 10:1 to 1:10 and most preferably from 5:1 to 1:5, for example from 4:1 to 1:4, or the weight ratio of the at least one water soluble or water dispersible source of bismuth ions to the at least one water soluble or water dispersible source of potassium ions [Bi/K] is from 100:1 to 1:100, preferably from 10:1 to 1:10 and most preferably from 5:1 to 1:5, for example from 4:1 to 1:4, or the weight ratio of the at least one water soluble or water dispersible source of magnesium ions to the at least one water soluble or water dispersible source of potassium ions [Mg/K] is from 100:1 to 1:100, preferably from 10:1 to 1:10 and most preferably from 5:1 to 1:5, for example from 4:1 to 1:4, or the weight ratio of the at least one water soluble or water dispersible source of sodium ions to the at least one water soluble or water dispersible source of potassium ions [Na/K] is from 100:1 to 1:100, preferably from 10:1 to 1:10 and most preferably from 5:1 to 1:5, for example from 4:1 to 1:4, or the weight ratio of the at least one water soluble or water dispersible source of zinc ions to the at least one water soluble or water dispersible source of potassium ions [Zn/K] is from 100:1 to 1:100, preferably from 10:1 to 1:10 and most preferably from 5:1 to 1:5, for example from 4:1 to 1:4.

According to a preferred embodiment, the storage stabilization agent comprises preferably consist of water and at least one water soluble or water dispersible source of sodium ions, for example sodium carbonate, in combination with a water soluble or water dispersible source of zinc ions, for example zinc oxide, wherein the weight ratio of the at least one water soluble or water dispersible source of sodium ions to the at least one water soluble or water dispersible source of zinc ions [Na/Zn] is from 3:1 to 5:1, preferably from 3.5:1 to 4.5:1 and most preferably is 4:1.

According to an exemplified method of the present invention, the storage stabilization agent for stabilizing an aqueous composition upon storage comprises, preferably consist of at least one water soluble or water dispersible source of sodium ions in combination with at least one water soluble or water dispersible source of zinc ions. Preferably, the storage stabilization agent comprises water and preferably each of the water soluble or water dispersible sources of ions are present in the composition in an amount from 1000 to 5000 ppm, calculated relative to the weight of water.

According to another exemplified method of the present invention, the storage stabilization agent for stabilizing an aqueous composition upon storage comprises, preferably consist of at least one water soluble or water dispersible source of magnesium ions in combination with at least one water soluble or water dispersible source of zinc ions. Additionally, the storage stabilization agent for stabilizing an aqueous composition upon storage comprises at least one water soluble or water dispersible source of bismuth ions. Preferably, the storage stabilization agent comprises water and preferably each of the water soluble or water dispersible sources of ions are present in the composition in an amount from 1000 to 5000 ppm, calculated relative to the weight of water.

According to another exemplified method of the present invention, the storage stabilization agent for stabilizing an aqueous composition upon storage comprises, preferably consist of at least one water soluble or water dispersible source of bismuth ions in combination with at least one water soluble or water dispersible source of sodium ions. Preferably, the storage stabilization agent comprises water and preferably each of the water soluble or water dispersible sources of ions are present in the composition in an amount from 1000 to 5000 ppm, calculated relative to the weight of water.

According to another exemplified method of the present invention, the storage stabilization agent for stabilizing an aqueous composition upon storage comprises, preferably consist of at least one water soluble or water dispersible source of sodium ions in combination with at least one water soluble or water dispersible source of potassium ions. Preferably, the storage stabilization agent comprises water and preferably each of the water soluble or water dispersible sources of ions are present in the composition in an amount from 1000 to 5000 ppm, calculated relative to the weight of water.

The inventors surprisingly found that the inventive storage stabilization agent is able to stabilize an aqueous composition upon storage. More precisely, the storage stabilization agent stabilizes the aqueous composition for a defined amount of time against pH change and/or against microorganisms, viruses and/or bacteriophages. Thus, one additive can be used for either stabilizing the aqueous composition for a defined amount of time against pH change or for preventing the growth of microorganisms, viruses and/or bacteriophages and, therefore, the storage stabilization agent is easy to handle since no differentiation between these two functionalities has to be made. According to a preferred embodiment, only one additive, namely the storage stabilization agent is needed in order to fulfil two functionalities, namely the stabilization of the pH value und the reduction or prevention of microbial growth. Furthermore, in addition to the storage stabilization agent no further antimicrobials are necessary to prevent or reduce microbial growth. Furthermore, the inventive storage stabilization agent of the present invention is easy to handle, cheap, and is not toxic to humans, animals and/or the environment. Furthermore, the storage stabilization agent is insensitive to decay by pH or temperature, and is inert to chemical reactions.

### Further Additives

According to another embodiment of the present invention, the storage stabilization agent is free of at least one water soluble or water dispersible source of lithium ions. Therefore, no lithium ions are present in the storage stabilization agent. In the meaning of the present invention, the term “source” of lithium ions in the meaning of the present invention refers to a compound that comprises, preferably consists of, lithium ions, i.e. lithium cations.

According to another embodiment of the present invention, the storage stabilization agent comprises further additives selected from the group comprising dispersing agents, viscosity agents, thickeners, rheological additives and defoaming agents. Such further additives are known to the skilled person and are commercially available.

According to a preferred embodiment of the present invention, the storage stabilization agent comprises further at least one dispersing agent, for keeping the water dispersible sources of ions dispersed, in case water or a solvent is present in the storage stabilization agent. A suitable dispersing agent according to the present invention is preferably a homo or copolymer made of monomers and/or co-monomers selected from the group consisting of acrylic acid, methacrylic acid, itaconic acid, crotonic acid, fumaric acid, maleic anhydride acid, isocrotonic acid, aconitic acid (cis or trans), mesaconic acid, sinapinic acid, undecylenic acid, angelic acid, canellic acid, hydroxyacrylic acid, acrolein, acrylamide, acrylonitrile, dimethylaminoethyl methacrylate, vinylpyrrolidone, styrene, the esters of acrylic and methacrylic acids and mixtures thereof, wherein salts of poly(acrylic acid) and/or poly (methacrylic acid) are preferred as dispersing agent. The dispersing agent can be present in the storage stabilization agent in an amount from 0.001 to 15 wt.-%, based on the total weight of the storage stabilization agent, preferably in an amount from 0.01 to 10 wt.-% and most preferably in an amount from 0.1 to 7.5 wt.-%.

### Aqueous Preparation

The storage stabilization agent is preferably used to stabilize an aqueous preparation upon storage. By “stabilizing upon storage” it is meant that an aqueous composition is stabilized for a defined amount of time against pH change and/or against microorganisms, viruses and/or bacteriophages. More precisely, by stabilizing upon storage it is meant that an aqueous composition, stored motionless at 25° C., does not exhibit a change in the pH value of more than ±2, preferable not more than ±1 pH-unit and/or does prevent or reduce microbial growth of microorganisms, viruses and/or bacteriophages for at least 15 days. The aqueous preparation can be any kind of aqueous preparation in need of stabilization upon storage.

More precisely, the aqueous preparation comprises the storage stabilization agent.

With regard to the definition of the storage stabilization agent and preferred embodiments thereof, reference is made to the statements provided above when discussing the technical details of the storage stabilization agent of the present invention.

The aqueous preparation is preferably a paper making formulation, a paper coating formulation, fibre formulation, food formulation, pharmaceutical formulation, cosmetic formulation, plastic formulation, plaster formulation, varnish formulation, joint filler formulation, adhesive formulation, metal working fluid, cooling fluid, primer coat, levelling compound, and/or a paint formulation.

The term “aqueous” preparation refers to a system, wherein the liquid phase of the preparation or composition comprises, preferably consists of, water. However, said term does not exclude that the aqueous preparation or composition comprises an organic solvent, preferably selected from the group comprising methanol, ethanol, acetone, acetonitrile, tetrahydrofuran and mixtures thereof. If the aqueous preparation or composition comprises an organic solvent, the aqueous preparation or composition comprises the organic solvent in an amount up to 40.0 wt.-% preferably from 0.1 to 30.0 wt.-% and most preferably from 0.1 to 20.0 wt.-%, and preferably 0.1 to 10 wt.-% based on the total weight of the liquid phase of the aqueous preparation or composition.

According to a preferred embodiment, the liquid phase of the aqueous preparation or composition consists of water. If the liquid phase of the aqueous preparation or composition consists of water, the water to be used can be any water available such as tap water and/or deionised water.

Thus, the aqueous preparation comprises,
a) at least one water soluble or water dispersible source of bismuth ions and/or
b) at least one water soluble or water dispersible source of magnesium ions, and/or
c) at least one water soluble or water dispersible source of sodium ions, and/or
d) at least one water soluble or water dispersible source of potassium ions and/or
e) at least one water soluble or water dispersible source of zinc ions, and
f) water and
g) optional further materials and/or additives,
   with the proviso that the aqueous composition comprises at least two different water soluble or water dispersible ion sources.

According to one embodiment of the present invention, the inventive storage stabilization agent is present in an amount such that the pH value of the aqueous preparation is stabilized and the aqueous preparation is preserved against microorganisms, viruses and/or bacteriophages for at least 15 days, preferably for at least 20 days more preferably for at least 30 days, even more preferably at least 60 days and most preferably 90 days.

More precisely, when stored motionless at 25° C., the aqueous preparation comprising the storage stabilization agent does not exhibit a change in the pH value of more than ±2 preferable not more than ±1 pH-unit and/or does prevent or reduce microbial growth of microorganisms, viruses and/or bacteriophages for at least 15 days, preferably for at least 20 days more preferably for at least 30 days, even more preferably at least 60 days and most preferably 90 days.

The pH value is measured at 25° C. using a Mettler Toledo Seven Easy pH meter and a Mettler Toledo InLab Expert Pro pH electrode. A three point calibration (according to the segment method) of the instrument is first made using commercially available buffer solutions having pH values of 4, 7 and 10 at 25° C. (from Aldrich). The reported pH values are the endpoint values detected by the instrument (signal differs by less than 0.1 mV from the average over the last 6 seconds).

According to the present invention, the wording “prevents microbial growth” means that no significant growth of microorganisms such as at least one strain of bacteria, at least one strain of fungi, mold, yeast, algae and mixtures thereof as well as viruses and/or bacteriophages is observed in the aqueous preparation when the storage stabilization agent is present. This preferably does not lead to an increase of the cfu value in the treated aqueous preparation compared to the preparation immediately before treatment, more preferably to a decrease of the value to less than 100 cfu/1 ml or 1 g of the aqueous preparation and even more preferably to a decrease of the value to 80 to 100 1 ml or 1 g of the aqueous preparation using the bacterial count method described in the example section herein. It is appreciated that the final aqueous preparation, i.e. comprising the storage stabilization agent, is diluted by a factor of 10 and 100 μl of the diluted composition is then plated out in order to evaluate the microbial growth.

According to the present invention, the wording “reduce microbial growth” means that growth of microorganisms such as at least one strain of bacteria, at least one strain of fungi, mold, yeast, algae and mixtures thereof as well as viruses and/or bacteriophages is slower in the aqueous preparation when the storage stabilization agent is present. This preferably leads to a lower cfu value in the treated aqueous preparation compared to the preparation without the storage stabilization agent before treatment, more preferably to a value of less than 100 cfu/1 ml or 1 g of the aqueous preparation and even more preferably to a decrease of the value to 80 to 100 1 ml or 1 g of the aqueous preparation using the bacterial count method described in the example section herein. It is appreciated that the final aqueous preparation, i.e. comprising the storage stabilization agent, is diluted by a factor of 10 and 100 μl of the diluted composition is then plated out in order to evaluate the microbial growth.

Preferably, the storage stabilization agent is effective against microorganisms selected from the group consisting of at least one strain of bacteria, at least one strain of fungi, mold, yeast, algae and mixtures thereof as well as viruses and bacteriophages.

In one embodiment of the present invention, the at least one strain of bacteria is selected from the group consisting of gram-negative bacteria, gram-positive bacteria and mixtures thereof.

It is appreciated that gram-positive and gram-negative bacteria are well known in the art and are e.g. described in Biology of Microorganisms, “Brock”, Madigan M T, Martinko J M, Parker J, 1997, 8^{th} Edition. In particular, such bacteria represent evolutionary very distantly related classes of bacteria each comprising of many bacterial families. Gram negative bacteria are characterized by two membranes (outer and inner membrane) while gram positive bacteria contain only one membrane. Usually, the former contains a high amount of lipopolysaccharide and a thin single-layer of peptidoglycan, while the latter has virtually no lipopolysaccharide, a multi-layered thick peptidoglycan and the coat contains teichoic acids. For these differences, the Gram positive and Gram negative bacteria react differently on environmental influences. Methods for discriminating gram-positive and gram-negative bacteria include species identification by DNA sequencing techniques or biochemical characterisations. Alternatively, the number of membranes can be determined directly by thin section transmission electron microscopy.

The term “at least one strain of bacteria” in the meaning of the present invention means that the strain of bacteria comprises, preferably consists of, one or more strains of bacteria.

In one embodiment of the present invention, the at least one strain of bacteria comprises, preferably consists of, one strain of bacteria. Alternatively, the at least one strain of bacteria comprises, preferably consists of, two or more strains of bacteria. For example, the at least one strain of bacteria comprises, preferably consists of, two or three strains of bacteria. Preferably, the at least one strain of bacteria comprises, preferably consists of, two or more strains of bacteria.

In one embodiment, the storage stabilization agent is effective against at least one strain of bacteria which is selected from the group consisting of Pseudomonas sp., such as Pseudomonas aeruginosa, Pseudomonas pseudoalcaligenes, Pseudomonas putida, Pseudomonas stutzeri, Pseudomonas mendocina, Pseudomonas oleovorans subsp. Oleovorans, and mixtures thereof, Burkholderia sp., such as Burkholderia cepacia; Escherichia spp. such as Escherichia coli; Alcaligenes sp. such as Alcaligenes faecalis; Staphylococcus sp. such as Staphylococcus aureus; Enterococcus sp. such as Enterococcus faecalis; Bacillus sp. such as Bacillus halodurans; Salmonella sp.; Legionella, Comomonas aquatica, Brevundimonas intermedia, Rhizobium radiobacter, Spingobium yanoikuyae, Caldimonas sp., Hydrogenophaga sp., Alishewanella agri, Arthrobacter sp., Chryseomicrobium amylolyticum, Microbacterium sp., Exiguobacterium aurantiacum, and mixtures thereof.

For example, the storage stabilization agent is effective against at least one strain of bacteria which is selected from the group comprising Pseudomonas sp., such as Pseudomonas aeruginosa, Pseudomonas pseudoalcaligenes, Pseudomonas putida, and mixtures thereof, Burkholderia sp., such as Burkholderia cepacia; Escherichia spp. such as Escherichia coli; Alcaligenes sp. such as Alcaligenes faecalis; Staphylococcus sp. such as Staphylococcus aureus; Enterococcus sp. such as Enterococcus faecalis; Bacillus sp.; Salmonella sp.; Legionella, and mixtures thereof.

Additionally or alternatively, the storage stabilization agent is effective against at least one strain of fungi which is selected from the group comprising Saccharomyces cerevisiae, Pichia membranifaciens, Rhodotorula mucilaginosa Fusarium sp., Aspergillus sp. such as Aspergillus niger, Aspergillus brasiliensis, and mixtures thereof, Penicillium sp. such as Penicillium pinophilum, Penicillium funiculosum, and mixtures thereof, Aureobasidium pullulans, Geotrichum sp., Acremonium sp., Alternaria sp., Cladosporium sp., Mucor sp., Rhizopus sp., Stachybotrys sp., Trichoderma sp., Dematiaceae sp., Phoma sp., Eurotium sp., Scopulariopsis sp., Aureobasidium sp., Monilia sp., Botrytis sp., Stemphylium sp., Chaetomium sp., Mycelia sp., Neurospora sp., Ulocladium sp., Paecilomyces sp., Wallemia sp., Curvularia sp., and mixtures thereof.

For example, the storage stabilization agent is effective against at least one strain of fungi which is selected from the group comprising Saccharomyces cerevisiae, Pichia membranifaciens, Rhodotorula mucilaginosa Fusarium sp., Aspergillus sp., and mixtures thereof.

It is appreciated that moulds and yeasts are subclasses of fungis. Accordingly, the at least one strain of fungi can be at least one strain of mould or at least one strain of yeast.

Thus, the storage stabilization agent can be effective against at least one strain of mould which is selected from the group comprising Acremonium sp., Alternaria sp., Aspergillus sp., Cladosporium sp., Fusarium sp., Mucor sp., Penicillium sp., Rhizopus sp., Stachybotrys sp., Trichoderma sp., Dematiaceae sp., Phoma sp., Eurotium sp., Scopulariopsis sp., Aureobasidium sp., Monilia sp., Botrytis sp., Stemphylium sp., Chaetomium sp., Mycelia sp., Neurospora sp., Ulocladium sp., Paecilomyces sp., Wallemia sp., Curvularia sp., and mixtures thereof.

The term “at least one strain of mould” in the meaning of the present invention means that the strain of mould comprises, preferably consists of, one or more strains of mould.

In one embodiment of the present invention, the at least one strain of mould comprises, preferably consists of, one strain of mould. Alternatively, the at least one strain of mould comprises, preferably consists of, two or more strains of mould. For example, the at least one strain of mould comprises, preferably consists of, two or three strains of mould. Preferably, the at least one strain of mould comprises, preferably consists of, two or more strains of mould.

Additionally or alternatively, the storage stabilization agent can be effective against at least one strain of yeast which is selected from the group comprising Saccharomyces cerevisiae, Pichia membranifaciens, Rhodotorula mucilaginosa, and mixtures thereof.

The term “at least one strain of yeast” in the meaning of the present invention means that the strain of yeast comprises, preferably consists of, one or more strains of yeast.

In one embodiment of the present invention, the at least one strain of yeast comprises, preferably consists of, one strain of yeast. Alternatively, the at least one strain of yeast comprises, preferably consists of, two or more strains of yeast. For example, the at least one strain of yeast comprises, preferably consists of, two or three strains of yeast. Preferably, the at least one strain of yeast comprises, preferably consists of, two or more strains of yeast.

Additionally or alternatively, the storage stabilization agent can be effective against at least one strain of algae which is selected from the group comprising Chlorella vulgaris, Chlorella emersonii, Stichococcus bacillaris, Pleurococcus sp., Anacystis montana, and mixtures thereof.

The term “at least one strain of algae” in the meaning of the present invention means that the strain of algae comprises, preferably consists of, one or more strains of algae.

In one embodiment of the present invention, the at least one strain of algae comprises, preferably consists of, one strain of algae. Alternatively, the at least one strain of algae comprises, preferably consists of, two or more strains of algae. For example, the at least one strain of algae comprises, preferably consists of, two or three strains of algae. Preferably, the at least one strain of algae comprises, preferably consists of, two or more strains of algae.

Surprisingly, it has been found that the present storage stabilization agent stabilizes the pH value of an aqueous preparation in that the preparation does not exhibit a change in the pH value of more than ±2, preferable not more than ±1 pH-unit and/or does prevent or reduce microbial growth of microorganisms, viruses and/or bacteriophages for at least 15 days, preferably for at least 20 days more preferably for at least 30 days, even more preferably at least 60 days and most preferably 90 days without the use of conventional antimicrobials which might be toxic and/or harmful to humans, animals and/or the environment.

Thus, the storage stabilization agent and the aqueous preparation is preferably free of an antimicrobial selected from the group comprising phenols, halogenated phenols, halogen-containing compounds, halogen-releasing compounds, isothiazolinones, aldehyde-containing compounds, aldehyde-releasing compounds, guanidines, sulfones, thiocyanates, pyrithiones, antibiotics such as β-lactam antibiotics, quaternary ammonium salts, peroxides, perchlorates, amides, amines, heavy metals (other than zinc ions), biocidal enzymes, biocidal polypeptides, azoles, carbamates, glyphosates, sulphonamides and mixtures thereof. Such antimicrobials are well known to the skilled person.

However, it is to be noted that it is not excluded that the storage stabilization agent further comprises minor amounts of one or more of antimicrobial compounds.

According to one embodiment of the present invention, the inventive storage stabilization agent is present in the aqueous preparation in an amount such that each of the at least one water soluble or water dispersible source of bismuth ions, the at least one water soluble or water dispersible source of magnesium ions, the at least one water soluble or water dispersible source of sodium ions, the at least one water soluble or water dispersible source of potassium ions and the at least one water soluble or water dispersible source of zinc ions are present in the composition in an amount from 1000 to 10000 ppm, preferably in an amount from 1500 to 8000 ppm, even more preferably in an amount from 2000 to 7000 ppm, and most preferably in an amount from 2500 to 5000 ppm, calculated relative to the weight of water of the aqueous preparation, with the proviso that at least two different water soluble or water dispersible ion sources are present.

That is to say, the storage stabilization is present in the aqueous preparation in such an amount that the:
a) at least one water soluble or water dispersible source of bismuth ions in an amount from 1000 to 10000 ppm, preferably in an amount from 1500 to 8000 ppm, even more preferably in an amount from 2000 to 7000 ppm, and most preferably in an amount from 2500 to 5000 ppm, calculated relative to the weight of water, and/or
b) at least one water soluble or water dispersible source of magnesium ions in an amount from 1000 to 10000 ppm, preferably in an amount from 1500 to 8000 ppm, even more preferably in an amount from 2000 to 7000 ppm, and most preferably in an amount from 2500 to 5000 ppm, calculated relative to the weight of water and/or
c) at least one water soluble or water dispersible source of sodium ions in an amount from 1000 to 10000 ppm, preferably in an amount from 1500 to 8000 ppm, even more preferably in an amount from 2000 to 7000 ppm, and most preferably in an amount from 2500 to 5000 ppm, calculated relative to the weight of water and/or
d) at least one water soluble or water dispersible source of potassium ions in an amount from 1000 to 10000 ppm, preferably in an amount from 1500 to 8000 ppm, even more preferably in an amount from 2000 to 7000 ppm, and most preferably in an amount from 2500 to 5000 ppm, calculated relative to the weight of water and/or
e) at least one water soluble or water dispersible source of zinc ions in an amount from 1000 to 10000 ppm, preferably in an amount from 1500 to 8000 ppm, even more preferably in an amount from 2000 to 7000 ppm, and most preferably in an amount from 2500 to 5000 ppm, calculated relative to the weight of water
with the proviso that at least two different water soluble or water dispersible ion sources are present.

According to another embodiment of the present invention, the aqueous preparation preferably comprises at least one inorganic particulate material.

The term “at least one” inorganic particulate material in the meaning of the present invention means that the inorganic particulate material comprises, preferably consists of, one or more inorganic particulate materials.

In one embodiment of the present invention, the at least one inorganic particulate material comprises, preferably consists of, one inorganic particulate material. Alternatively, the at least one inorganic particulate material comprises, preferably consists of, two or more inorganic particulate materials. For example, the at least one inorganic particulate material comprises, preferably consists of, two or three inorganic particulate material. Preferably, the at least one inorganic particulate material comprises, preferably consists of, one inorganic particulate material.

For example, the at least one inorganic particulate material is selected from the group comprising natural ground calcium carbonate, natural and/or synthetic precipitated calcium carbonate, surface-modified calcium carbonate, dolomite, kaolin, clay, barite, talcum, aluminium hydroxide, aluminium silicate, titanium dioxide, hydromagnesite, perlite, sepiolite, brucite and mixtures thereof.

In one embodiment of the present invention, the at least one inorganic particulate material comprises natural ground calcium carbonate and/or synthetic precipitated calcium carbonate and/or surface-modified calcium carbonate. Preferably, the at least one inorganic particulate material comprises natural ground calcium carbonate and/or synthetic precipitated calcium carbonate.

“Ground calcium carbonate” (GCC) in the meaning of the present invention is a calcium carbonate obtained from natural sources, such as limestone, marble or chalk, and processed through a treatment such as grinding, screening and/or fractionizing by wet and/or dry, for example by a cyclone or classifier.

“Precipitated calcium carbonate” (PCC) in the meaning of the present invention is a synthesized material, generally obtained by precipitation following reaction of carbon dioxide and lime in an aqueous environment or by precipitation of a calcium and carbonate ion source in water.

A “surface-modified calcium carbonate” may feature surface-reacted GCC or PCC. A surface-reacted calcium carbonate may be prepared by providing a GCC or PCC in form of an aqueous suspension, and adding an acid to said suspension. Suitable acids are, for example, sulphuric acid, hydrochloric acid, phosphoric acid, citric acid, oxalic acid, or a mixture thereof. In a next step, the calcium carbonate is treated with gaseous carbon dioxide. If a strong acid such as sulphuric acid or hydrochloric acid is used for the acid treatment step, the carbon dioxide will form automatically in situ. Alternatively or additionally, the carbon dioxide can be supplied from an external source. Surface-reacted calcium carbonates are described, for example, in US20120031576 A1, WO2009074492 A1, EP2264109 A1, EP2070991 A1, EP2264108 A1, WO0039222 A1, WO2004083316 A1 or WO2005121257 A2.

The natural ground calcium carbonate and/or synthetic precipitated calcium carbonate and/or surface-modified calcium carbonate may additionally be surface treated or may comprise a dispersing agent well known to the skilled person. For example, the dispersing agent may be an acrylate-based dispersing agent.

If the aqueous preparation comprises at least one inorganic particulate material, the at least one inorganic particulate material may have a particle size distribution as conventionally employed for the material(s) involved in the type of product to be produced. In general, 90% of the particles will have an esd (equivalent spherical diameter as measured by the well-known technique of sedimentation using Sedigraph 5120 series, Micromeritics) of less than 5 μm. Coarse inorganic particulate materials may have a particle esd generally (i.e., at least 90 wt.-%) in the range of 1 to 5 μm. Fine inorganic particulate materials may have a particle esd generally less than 2 μm, e.g. 50.0 to 99.0 wt.-% less than 2 μm and preferably 60.0 to 90.0 wt.-% less than 2 μm. It is preferred that the at least one inorganic particulate material in the aqueous preparation has a weight median particle size d₅₀ value of from 0.1 to 5 μm, preferably from 0.2 to 2 μm and most preferably from 0.35 to 1 μm, for example 0.7 μm as measured using a Sedigraph™ 5120 of Micromeritics Instrument Corporation.

The “particle size” of particulate materials herein is described by its distribution of particle sizes dₓ(wt). Therein, the value dₓ(wt) represents the diameter relative to which x % by weight of the particles have diameters less than dₓ(wt). This means that, for example, the d₂₀ (wt) value is the particle size at which 20 wt. % of all particles are smaller than that particle size. The d₅₀ (wt) value is thus the weight median particle size, i.e. 50 wt. % of all particles are smaller than that particle size and the d₉₈ (wt) value, referred to as weight-based top cut, is the particle size at which 98 wt. % of all particles are smaller than that particle size. The weight-based median particle size d₅₀ (wt) and top cut d₉₈ (wt) are measured by the sedimentation method, which is an analysis of sedimentation behaviour in a gravimetric field. The measurement is made with a Sedigraph™ 5120 of Micromeritics Instrument Corporation, USA. The method and the instrument are known to the skilled person and are commonly used to determine particle size distributions. The measurement is carried out in an aqueous solution of 0.1 wt. % Na₄P₂O₇. The samples are dispersed using a high speed stirrer and sonication.

For keeping such inorganic particulate materials dispersed in an aqueous preparation and thus ensuring that the viscosity of the preparation remains substantially the same over time, additives such as dispersing agents can be used. A suitable dispersing agent according to the present invention is preferably a homo or copolymer made of monomers and/or co-monomers selected from the group consisting of acrylic acid, methacrylic acid, itaconic acid, crotonic acid, fumaric acid, maleic anhydride acid, isocrotonic acid, aconitic acid (cis or trans), mesaconic acid, sinapinic acid, undecylenic acid, angelic acid, canellic acid, hydroxyacrylic acid, acrolein, acrylamide, acrylonitrile, dimethylaminoethyl methacrylate, vinylpyrrolidone, styrene, the esters of acrylic and methacrylic acids and mixtures thereof, wherein salts of poly(acrylic acid) and/or poly (methacrylic acid) are preferred as dispersing agent.

Additionally or alternatively, the aqueous preparation comprises at least one organic particulate material. For example, the at least one organic material is selected from the group comprising carbohydrates such as CMC or starch, sugar, cellulose, modified cellulose and cellulose based pulp, glycerol, hydrocarbons and mixtures thereof.

In one embodiment of the present invention, the aqueous preparation comprises at least one inorganic particulate material, preferably being selected from the group comprising natural ground calcium carbonate, natural and/or synthetic precipitated calcium carbonate, surface-modified calcium carbonate, dolomite, kaolin, clay, barite, talcum, aluminium hydroxide, aluminium silicate, titanium dioxide, hydromagnesite, perlite, sepiolite, brucite and mixtures thereof, and most preferably the at least one inorganic particulate material comprises natural ground calcium carbonate and/or synthetic precipitated calcium carbonate.

Thus, the aqueous preparation is preferably an aqueous suspension or slurry.

It is appreciated that the solids content of the aqueous preparation can be up to 85.0 wt.-%. For example, the solids content of the aqueous preparation is from 10.0 to 82.0 wt.-%, and more preferably from 20.0 to 80.0 wt.-%, based on the total weight of the aqueous preparation.

The total solids content in the meaning of the present application corresponds to the residual weight of the aqueous preparation after drying for 3 h at 105° C. as measured in a sample of at least 3 to 5 g.

The pH of the aqueous preparation can vary in a broad range and is preferably in a pH range typically observed for such aqueous preparations. It is thus appreciated that the aqueous preparation preferably has a pH value of from 3 to 14, more preferably from 5 to 14, even more preferably from 7 to 14, even more preferably from 7.5 to 11.5 and most preferably from 8 to 11.

Typically, the aqueous preparation has a viscosity being preferably in the range from 50 to 2000 mPa·s and preferably from 80 to 800 mPa·s. The Brookfield viscosity is for this purpose measured by a Brookfield DV-II+ Pro viscometer at 25° C.±1° C. at 100 rpm using an appropriate spindle of the Brookfield RV-spindle set and is specified in mPa·s.

The aqueous preparations according to the invention can be produced by methods known in the art, by for example, dispersing, suspending or slurring water-insoluble solids, preferably inorganic particulate materials with, if appropriate, addition of a dispersing agent and, if appropriate, further additives in water.

### Process for Stabilizing the Aqueous Preparation Upon Storage

The present invention also refers to a process for stabilizing the aqueous preparation upon storage, said process comprises the steps of
a) providing an aqueous preparation, preferably a paper making formulation, a paper coating formulation, fibre formulation, food formulation, pharmaceutical formulation, cosmetic formulation, plastic formulation, plaster formulation, varnish formulation, joint filler formulation, adhesive formulation, metal working fluid, cooling fluid, primer coat, levelling compound, and/or a paint formulation,
b) providing an storage stabilization agent as defined herein, and
c) contacting and mixing the aqueous preparation of step a) with the storage stabilization agent of step b) in any order for obtaining the stabilized aqueous preparation.

With regard to the definition of the aqueous preparation, the storage stabilization agent, the microorganisms, viruses and/or bacteriophages and preferred embodiments thereof, reference is made to the statements provided above when discussing the technical details of the aqueous preparation and the storage stabilization agent of the present invention.

According to step c) of the process of the present invention, the aqueous preparation of step a) is contacted and mixed with the storage stabilization agent of step b).

In general, the aqueous preparation of step a) and the at least one storage stabilization agent of step b) can be brought into contact by any conventional means known to the skilled person.

It is appreciated that step c) is preferably carried out by adding the storage stabilization agent of step b) to the aqueous preparation of step a).

Preferably, the step c) is carried out in that the storage stabilization agent is added to the aqueous preparation under mixing. A sufficient mixing may be achieved by shaking the aqueous preparation or by agitation, which may provide a more thorough mixing. In one embodiment of the present invention, step c) is carried out under agitation to ensure a thorough mixing of the aqueous preparation and the storage stabilization agent. Such agitation can be carried out continuously or discontinuously.

In one embodiment, step c) is carried out in that the storage stabilization agent is added to the aqueous preparation in an amount such that the amount of each of the at least two different water soluble or water dispersible ion sources selected from the group consisting of water soluble or water dispersible source of bismuth ions, water soluble or water dispersible source of magnesium ions, water soluble or water dispersible source of sodium ions, water soluble or water dispersible source of potassium ions and water soluble or water dispersible source of zinc ions is present in the aqueous preparation in an amount from 1000 to 10000 ppm, preferably in an amount from 1500 to 8000 ppm, even more preferably in an amount from 2000 to 7000 ppm, and most preferably in an amount from 2500 to 5000 ppm, calculated relative to the weight of water.

It is appreciated that the amount of each of the at least one water soluble or water dispersible source of bismuth ions, water soluble or water dispersible source of magnesium ions, water soluble or water dispersible source of sodium ions, water soluble or water dispersible source of potassium ions and water soluble or water dispersible source of zinc ions can vary in a great range in the aqueous preparation.

It is to be noted that the aforementioned amounts reflect the amount of the antimicrobial composition being added via the at least one water soluble or water dispersible source of bismuth ions, water soluble or water dispersible source of magnesium ions, water soluble or water dispersible source of sodium ions, water soluble or water dispersible source of potassium ions and water soluble or water dispersible source of zinc ions to the aqueous preparation and do not cover any dissolved bismuth, magnesium, sodium, potassium and zinc ions which may naturally be present in the aqueous preparation.

It is appreciated that the single components of the storage stabilization agent can be added to the aqueous preparation as a pre-mixed composition or in form of the single components.

In one embodiment, the single components of the storage stabilization agent can be added to the aqueous preparation in dry form or in form of a solution or slurry or dispersion.

The amount of the at least one water soluble or water dispersible source of bismuth ions, water soluble or water dispersible source of magnesium ions, water soluble or water dispersible source of sodium ions, water soluble or water dispersible source of potassium ions and water soluble or water dispersible source of zinc ions added to the aqueous preparation can be individually adjusted depending on the aqueous preparation. In particular, the amount of the storage stabilization agent and the single components therein depends on the nature and the occurrence of the at least one water soluble or water dispersible source of bismuth ions, water soluble or water dispersible source of magnesium ions, water soluble or water dispersible source of sodium ions, water soluble or water dispersible source of potassium ions and water soluble or water dispersible source of zinc ions to be used in the aqueous preparation. The optimum amount to be employed within the defined ranges can be determined by preliminary tests and test series on a laboratory scale and by supplementary operational tests.

It is appreciated that step c) can be repeated one or more times.

The storage stabilization agent can be added in one or several portions to the aqueous preparation. If the storage stabilization agent is added in several portions, the storage stabilization agent can be added in about equal portions or unequal portions to the aqueous preparation.

The aqueous preparation obtained in step c) preferably has solids content corresponding to the solids content of the aqueous preparation provided in step a). It is thus appreciated that the aqueous preparation obtained in step c) preferably has solids content of up to 85.0 wt.-%, based on the total weight of the aqueous preparation obtained in step c). For example, the solids content of the aqueous preparation obtained in step c) is from 10.0 to 82.0 wt.-%, and more preferably from 20.0 to 80.0 wt.-%, based on the total weight of the aqueous preparation obtained in step c).

Additionally or alternatively, the pH of the aqueous preparation obtained in step c) preferably corresponds to the pH of the aqueous preparation provided in step a). Thus, the aqueous preparation obtained in step c) preferably has a pH value of from 3 to 14, more preferably from 5 to 14, even more preferably from 7 to 14, even more preferably from 7.5 to 11.5, and most preferably from 8 to 11.

Typically, the aqueous preparation obtained in step c) has a viscosity being preferably in the range from 50 to 2000 mPa·s and preferably from 80 to 800 mPa·s. The Brookfield viscosity is for this purpose measured by a Brookfield DV-II+ Pro viscometer at 25° C.±1° C. at 100 rpm using an appropriate spindle of the Brookfield RV-spindle set and is specified in mPa·s.

### The Use of the Storage Stabilization Agent

A further aspect of the present thus refers to the use of an storage stabilization agent as defined herein for stabilizing the pH value of an aqueous preparation and/or for preserving the aqueous preparation against microorganisms, viruses and/or bacteriophages.

It is preferred that the microorganisms are selected from the group comprising at least one strain of bacteria, at least one strain of fungi, mold, yeast, algae and mixtures thereof.

The aqueous preparation is preferably a paper making formulation, a paper coating formulation, fibre formulation, food formulation, pharmaceutical formulation, cosmetic formulation, plastic formulation, plaster formulation, varnish formulation, joint filler formulation, adhesive formulation, metal working fluid, cooling fluid, primer coat, levelling compound, and/or a paint formulation.

With regard to the definition of the aqueous preparation, the storage stabilization agent, the microorganisms, viruses and/or bacteriophages and preferred embodiments thereof, reference is made to the statements provided above when discussing the technical details of the aqueous preparation and the storage stabilization agent of the present invention.

The following examples are meant to illustrate the invention without restricting its scope.

### EXAMPLES

### Measurement Methods

The following measurement methods are used to evaluate the parameters given in the description, examples and claims.

### BET Specific Surface Area of a Material

The BET specific surface area was measured via the BET process according to ISO 9277:2010 using nitrogen, following conditioning of the sample by heating at 250° C. for a period of 30 minutes. Prior to such measurements, the sample was filtered, rinsed and dried at 110° C. in an oven for at least 12 hours.

Particle Size Distribution (Mass % Particles with a Diameter <X) and Weight Median Diameter (d₅₀) and d₉₈ Value of a Particulate Material

Weight median grain diameter and grain diameter mass distribution of a particulate material were determined via the sedimentation process, i.e. an analysis of sedimentation behaviour in a gravitational field. The measurement was made with a Sedigraph™ 5100 of Micromeritics Instrument Corporation.

The method and the instrument are known to the skilled person and are commonly used to determine grain size of fillers and pigments. The measurement is carried out in an aqueous solution of 0.1 wt.-% Na₄P₂O₇. The samples are dispersed using a high speed stirrer and supersonics.

### pH Measurement

The pH of the water samples is measured at 25° C. by using a Mettler Toledo Seven Easy pH meter and a Mettler Toledo InLab® Expert Pro pH electrode. A three point calibration (according to the segment method) of the instrument was first made using commercially available buffer solutions having pH values of 4, 7 and 10 at 20° C. (from Aldrich). The reported pH values were the endpoint values detected by the instrument (the endpoint was when the measured signal differs by less than 0.1 mV from the average over the last 6 seconds).

### Brookfield-Viscosity

All Brookfield-viscosities are measured with a Brookfield DV-II Viscometer equipped with a LV-3 spindle at a speed of 100 rpm and room temperature (20±3° C.) and are specified in mPa·s. Once the spindle has been inserted into the sample, the measurement is started with a constant rotating speed of 100 rpm. The reported Brookfield viscosity values are the values displayed 60 seconds after the start of the measurement.

### Amount of Additives

Unless otherwise stated, all amounts quoted in ppm represent mg values per kilogram of water in the aqueous preparation. Concentrations are further quoted in mmol/kg (millimol per kilogram) or mol/1 (mol per litre) according to the International System of Units in the water of the aqueous preparation.

### Bacterial Count

All quoted bacterial counts in the Tables here below are either cfu/ml (colony forming units per gram) or cfu/plate (colony forming units per plate) wherein cfu/g were determined after 2-3 days following plate-out and in accordance with counting method described in “Bestimmung von aeroben mesophilen Keimen”, Schweizerisches Lebensmittelbuch, chapter 56, section 7.01, edition of 1985, revised version of 1988. Unless otherwise stated, per tryptic soy agar plate (TSA, prepared using BD 236950) 0.1 ml of a 1:10 dilution in phosphate buffered saline (PBS; pH=7.4, 137 mmol/1 NaCl, 2.7 mmol/1 KCl, 10 mmol/1 Na₂HPO₄, 1.8 mmol/1 KH₂PO₄) was plated. TSA plates were then incubated for 48 h or 72 h at 30° C. Colony forming units (cfu) were then counted and reported as cfu/plate. Counts from of 100 000 cfu/g and above are reported as t.c. (totally contaminated).

### Solids Content

The solids content (also known as “dry weight”) is measured using a Moisture Analyzer of Mettler-Toledo MJ33 with the following settings: temperature of 120° C., automatic switch off 3, standard drying, 5 to 20 g of product. The method and the instrument are known to the skilled person.

### Amounts of Ions

All bismuth, magnesium, sodium, potassium and zinc amounts quoted in ppm correspond to mg values per kilogram of the final product.

### Preparation of Bacteria, Yeast and Mould Used (Mix-all)

Fresh bacteria cultures of the bacteria Pseudomonas sp., e.g. P. aeruginosa DSM-1707 and P. putida DSM-50906, P. pseudoalcaligenes DSM-50188T, Burkholderia cepacia, e.g. B. cepacia ATCC-21809, Alcaligenes faecalis, e.g. A. faecalis ATCC-25094, Escherichia coli DSM-1576, and Staphylococcus aureus, e.g. S. aureus strains DSM 346, and fresh Yeast cultures of Saccharomyces cervisiae DSM-1333; Pichia membranifaciens DSM-70179, and Rhodotorula mucilaginosa DSM-18184, were prepared by inoculation of 3 ml liquid growth media (tryptic soy broth, e.g. Fluka, No. 22092) from a single colony of a stock culture and incubation for 16 to 20 h at 30° C. with agitation at 150 rotations per minutes (rpm) leading to a cell density of approximately 1×10⁹ cells/ml. Over-night cultures of bacteria/yeast and fungi (in tryptic soy broth) were mixed together in equal quantities, 100 μl of the obtained mixture was added to 50 ml of base paint (see below).

### Materials

water soluble or water dispersible source of bismuth ions: bismuth chloride (BiCl₃), CAS: 7787-60-2; bismuth oxide (Bi₂O₃) CAS: 1304-76-3
water soluble or water dispersible source of zinc ions: zinc oxide (ZnO) CAS 1314-13-2
water dispersible source of magnesium ions: magnesium carbonate (MgCO₃) CAS 546-93-0
water soluble or water dispersible source of sodium ions: sodium carbonate (Na₂CO₃) CAS: 497-19-8,
water soluble or water dispersible source of potassium ions: potassium carbonate (K₂CO₃) CAS 584-08-7
commercial latex paint: white latex paint obtainable from JONAS Farben GmbH, Germany under the trade name 15 00 001 JONAS Seidenlatex (weiβ)

### Base Paint

The base paint formulation for testing antimicrobial activity is summarized in the following table 1a.

TABLE 1a

| Emulsion Paint | wt.-% | [kg] |
|---|---|---|
| Tap water | 31.7 | 317.0 |
| Wetting and dispersing agent^{#1} | 0.1 | 1.0 |
| Rheology modifier^{#2} | 0.5 | 5.0 |
| Sodium hydroxide, 10% | 0.1 | 1.0 |
| Defoamer^{#3} | 0.3 | 3.0 |
| Wetting and dispersing agent^{#4} | 0.3 | 3.0 |
| Rheology modifier^{#5} | 0.4 | 4.0 |
| White pigment^{#6} | 6.0 | 60.0 |
| Extender^{#7} | 13.0 | 130.0 |
| Extender^{#8} | 23.0 | 230.0 |
| Matting agent^{#9} | 7.0 | 70.0 |
| Extender^{#10} | 5.0 | 50.0 |
| Binder^{#11} | 12.2 | 122.0 |
| Defoamer^{#12} | 0.4 | 4.0 |
| Total | 100 | 1000.0 |

^{#1}The wetting and dispersing agent relates to a sodium polyphosphate which is commercially available as Calgon N new from BK Giulini Chemie.
^{#2}The rheology modifier relates to a methyl ethyl hydroxyethyl cellulose which is commercially available as Bermocoll Prime 3500 from AkzoNobel Corp..
^{#3}The defoamer relates to a mineral oil based defoamer which is commercially available as BYK 038 from Byk Chemie.
^{#4}The wetting and dispersing agent relates to a sodium salt of acrylic polymer which is commercially available as ECODIS P 50 from Coatex SA.
^{#5}The rheology modifier relates to a polyurethane which is commercially available as Coapur 2025 from Coatex SA.
^{#6}The white pigment relates to a titanium dioxide, which is commercially available as Titandioxid 2310 from Kronos.
^{#7}The extender relates to a dry ground calcium carbonate (marble from Italy) having a median diameter (d₅₀) of 0.8 μm and a top cut (d₉₈) of 5 μm which is commercially available as Omyacarb Extra - CL from Omya International AG.
^{#8}The extender relates to a dry ground calcium carbonate (marble from Italy) having a median diameter (d₅₀) of 4.5-6.5 μm, a sieve residue >100 μm of ≤30 ppm, and sieve residue >45 μm of ≤0.1% (ISO 787/7), which is commercially available as Omyacarb 5 - GU from Omya International AG.
^{#9}The matting agent relates to a dry ground calcium carbonate (marble from Italy) having a median diameter (d₅₀) of 20 μm, a sieve residue >60 μm of ≤0.8% and a sieve residue >45 μm of ≤2% (ISO 787/7), which is commercially available as Omya Calcimatt AV from Omya International AG.
^{#10}The extender relates to a dry ground calcium carbonate (marble from Italy) having a median diameter (d₅₀) of 6 μm and a top cut (d₉₈) of 19 μm, which is commercially available as FINNTALC M20SL-AW from Mondo Minerals.
^{#11}The binder relates to a non-plasticized aqueous polymer dispersion based on styrene and an acrylic acid ester (50% dispersion) which is commercially available as Mowilith LDM 1828 50% from Celanese.
^{#12}The defoamer relates to a polymer based, VOC- and silicone free based defoamer which is commercially available as BYK 012 from Byk Chemie.

### Scraper Plaster

The scraper plaster formulation for testing antimicrobial activity is summarized in the following table 1b. The formulation is for a scraper plaster (negative structure).

TABLE 1b

| Scraper plaster (negative structure) | wt.-% | [kg] |
|---|---|---|
| Tap Water | 10.2 | 102 |
| Bentone EW^{#13} | 0.1 | 1 |
| Tylose h 10000 YP2^{#14} | 0.1 | 1 |
| Dispex AA 4080^{#15} | 0.3 | 3 |
| Agitan 265^{#16} | 0.3 | 3 |
| Kronos 2310^{#17} | 2.0 | 20 |
| Omyacarb ®30 - NP^{#18} | 13.0 | 130 |
| ENCOR^{#19} | 13.0 | 130 |
| Carolith ® 0.0-0.2 - NP^{#20} | 21.5 | 215 |
| Carolith ® 0.2-0.5 - NP^{#21} | 28.0 | 280 |
| Carolith ® 1.0-1.5 - NP^{#22} | 10.5 | 105 |
| Arbocel P 400^{#23} | 0.5 | 5 |
| Lubranil N 20^{#24} | 0.5 | 5 |
| Total | 100 | 1000 |

^{#13}Bentone EW (rheological additive of refined and beneficiated clay, commercially available from Elementis)
^{#14}Tylose h 100000 YP2 (hydroxyethyl cellulose based thickener, commercially available from SE Tylose (Shin-Etsu))
^{#15}Dispex AA 4080 (dispersing agent based on ammonium salt of an acrylic polymer in water, commercially available from BASF)
^{#16}Agitan 265 (defoamer, based on a blend of modified nonionic fatty compound, hydrophobic silica and white oils, commercially available from Münzing)
^{#17}Kronos 2310 (rutile TiO2 pigment surface treated with aluminum, silicon and zirconium compounds, commercially available from Kronos)
^{#18}Omyacarb ® 30 - NP (calcium carbonate product with more than 98% of CaCO3 content and a d₅₀ from 28-40 μm, commercially available from Omya)
^{#19}Encor 2100 (styrene acrylic emulsion based binder, commercially available from Arkema)
^{#20}Carolith ® 0.0-0.2 NP (calcium carbonate product with more than 98% of CaCO3 content and particle sizes up to 0.2 mm, m commercially available from Omya)
^{#21}Carolith ® 0.2-0.5 NP (calcium carbonate product with more than 98% of CaCO3 content and particle sizes from 0.2 mm to 0.5 mm, commercially available from Omya)
^{#22}Carolith ® 1.0-1.5 NP (calcium carbonate product with more than 98% of CaCO3 content and particle sizes from 1 mm to 1.5 mm, commercially available from Omya)
^{#23}Arbocel P 400 (pure cellulose fiber based functional filler, commercially available from JRS)
^{#24}Lubranil N 20 (water based dispersion for plasters, commercially available from Münzing)

### Dispersion Based Adhesive for Wooden Floor

The adhesive formulation for testing antimicrobial activity is summarized in the following table 1c.

TABLE 1c

| Adhesive formulation | wt.-% | [kg] |
|---|---|---|
| Tap water | 5.0 | 5.0 |
| Calgon N neu^{#25} | 0.1 | 0.1 |
| Tylose H 15000 YP2^{#26} | 0.2 | 0.2 |
| Lopon 890^{#27} | 0.3 | 0.3 |
| Agitan 301^{#28} | 0.2 | 0.2 |
| Mowilit LDM 1025, 55%^{#29} | 43.2 | 43.2 |
| Omyacarb ® 10^{#30} | 51.0 | 51.0 |
| Total | 100 | 100 |

^{#25}Calgon N neu (Na-polyphosphate based wetting agent, dispersant, commercially available from BK Guilini)
^{#26}Tylose H 15000 YP2 (Hydroxethyl cellulose based thickener, commercially available form SE Tylose (Shin-Etsu))
^{#27}Lopon 890 (Na-polyacrylate based wetting agent, dispersant, commercially available from BK Guilini)
^{#28}Agitan 301 (anti-foaming agent bases on mineral oil (containing silicon oil), commercially available form Münzing)
^{#29}Mowilith LDM 1025, 55% (vinylacetate-ethylene based binder, commercially available from Celansese)
^{#30}Omyacarb ® 10 (calcium carbonate filler product with more than 97.5% of CaCO₃ content and a d₅₀ from 7-13 μm, commercially available from Omya)

### Dispersion Based Varnish

The varnish formulation for testing antimicrobial activity is summarized in the following table 1d

TABLE 1d

| Varnish composition | wt.-% | [kg] |
|---|---|---|
| Tap water | 45.0 | 45.0 |
| Encor 2100^{#31} | 25.0 | 25.0 |
| Bayhydrol ® UH 2881^{#32} | 15.0 | 15.0 |
| Agitan 301^{#33} | 0.3 | 0.3 |
| Calgon N neu^{#34} | 0.2 | 0.2 |
| Coapur 2025^{#35} | 1.9 | 1.9 |
| Pergopak M3 ^{#36} | 3.0 | 3.0 |
| Omyacarb ® 10^{#37} | 5.5 | 5.5 |
| Kronos 2310^{#38} | 4.1 | 4.1 |
| Total | 100 | 100 |

^{#31}Encor 2100 (styrene acrylic emulsion based binder, commercially available from Arkema)
^{#32}Bayhydrol ® UH 2881 (polyurethane based dispersion, commercially available form Covestro)
^{#33}Agitan 301 (anti-foaming agent bases on mineral oil (containing silicon oil), commercially available form Münzing)
^{#34}Calgon N neu (Na-polyphosphate based wetting agent, dispersant, commercially available from BK Guilini)
^{#35}Coapur 2025 (polyurethane based rheology modifier, commercially available as from Coatex SA)
^{#36} Pergopak M3 (Polymethyl urea resin based matting agent, commercially available from Deuteron)
^{#37}Omyacarb ® 10 (calcium carbonate filler product with more than 97.5% of CaCO₃ content and a d50 from 7-13 μm, commercially available from Omya)
^{#38}Kronos 2310 (rutile TiO₂ pigment surface treated with aluminum, silicon and zirconium compounds, commercially available from Kronos)

### Antimicrobial Activity Tests in Base Paint and Commercial Latex Paint

Samples of the base paint formulation or the commercial latex paint were mixed with different amounts of water soluble or water dispersible source of bismuth ions, water soluble or water dispersible source of magnesium ions, water soluble or water dispersible source of sodium ions, water soluble or water dispersible source of potassium ions and water soluble or water dispersible source of zinc ions according to claim 1 as set out in Table 2a.

All amounts quoted in ppm correspond to mg values per kilogram of the corresponding ion based on the total weight of the base formulation.

TABLE 2a

| Base paint | Bi₂O₃ | Na₂CO₃ | ZnO | MgCO₃ |
|---|---|---|---|---|
| samples | ppm | ppm | ppm | ppm |
| Control E0 | 0 | 0 | 0 | 0 |
| E1 | 3333 | 0 | 0 | 0 |
| E2 | 0 | 3333 | 0 | 0 |
| E3 | 0 | 0 | 3333 | 0 |
| E4 | 0 | 0 | 0 | 3333 |
| E5 | 3333 | 0 | 3333 | 3333 |
| E6 | 0 | 3333 | 3333 | 0 |
| E7 | 0 | 0 | 3333 | 3333 |

| Base paint | Bi₂O₃ | Na₂CO₃ | ZnO |
|---|---|---|---|
| samples | ppm | ppm | ppm |
| Control E8 | 0 | 0 | 0 |
| E9 | 2500 | 2500 | 0 |
| E10 | 2000 | 2000 | 0 |
| E11 | 0 | 2500 | 2500 |
| E12 | 0 | 2000 | 2000 |

| Base paint | Na₂CO₃ | ZnO | Bi₂O₃ |
|---|---|---|---|
| samples | ppm | ppm | ppm |
| Control E13 | 0 | 0 | 0 |
| E14 | 4000 | 4000 | 0 |
| E15 | 5000 | 5000 | 0 |
| E16 | 4000 | 0 | 4000 |
| E17 | 5000 | 0 | 5000 |
| Base paint | Na₂CO₃ | ZnO | Bi₂O₃ |
| samples | ppm | ppm | ppm |
| Control E18 | 0 | 0 | 0 |
| E19 | 5000 | 2500 | 0 |
| E20 | 2500 | 2500 | 2500 |

| Base paint | Na₂CO₃ | Bi₂O₃ | K₂CO₃ |
|---|---|---|---|
| samples | ppm | ppm | ppm |
| Control E21 | 0 | 0 | 0 |
| E22 | 3000 | 0 | 3000 |
| E23 | 2500 | 0 | 2500 |
| E24 | 1666 | 1666 | 1666 |
| E25 | 0 | 5000 | 5000 |
| E26 | 0 | 3000 | 3000 |
| E27 | 0 | 0 | 5000 |

| Base paint | Na₂CO₃ | ZnO |
|---|---|---|
| samples | ppm | ppm |
| Control E28 | 0 | 0 |
| E29 | 8000 | 2000 |
| E30 | 7000 | 1750 |
| E31 | 6000 | 1500 |
| E32 | 5000 | 1250 |
| E33 | 4000 | 1000 |

| Commercial latex | Na₂CO₃ | ZnO |
|---|---|---|
| paint samples | ppm | ppm |
| Control E34 | 0 | 0 |
| E35 | 8000 | 2000 |
| E36 | 7000 | 1750 |
| E37 | 6000 | 1500 |
| E38 | 5000 | 1250 |
| E39 | 4000 | 1000 |

Base paint formulations E1 to E33 and latex paint samples E34 to E39 comprising the antimicrobial compositions according to Table 2a were prepared, and aliquots of 50 ml of the base paint formulation or the commercial latex paint were mixed with an aliquot of 800 μl (Mix-all), well mixed and incubated at room temperature for one week in the dark. After one week, 100 μl of a 1:10 dilution of a PBS-buffer (Phosphate buffer saline 10 mM, pH 7.4, 137 mmol/l NaCl, 2.7 mmol/l KCl, 10 mmol/l Na₂HPO₄, 1.8 mmol/l KH₂PO₄) were plated out (100 colony forming units (cfu) per millilitre of paint) on standard TSA (Trypticase soy agar) plates, and incubated at 30° C. in a Binder 3.1 incubator. Samples were analysed after 48 h for growth of bacteria and after 72 h for growth of yeast/fungi/mould.

### Antimicrobial Activity Test in Scraper Plaster

Samples of the scraper plaster formulation were mixed with different amounts of water soluble or water dispersible source of bismuth ions, water soluble or water dispersible source of magnesium ions, water soluble or water dispersible source of sodium ions, water soluble or water dispersible source of potassium ions and water soluble or water dispersible source of zinc ions according to claim 1 as set out in Table 2b.

All amounts quoted in ppm correspond to mg values per kilogram of the corresponding ion based on the total weight of the scraper plaster formulation.

TABLE 2b

| Scraper plaster | Na₂CO₃ | K₂CO₃ | Bi₂O₃ |
|---|---|---|---|
| samples | ppm | ppm | ppm |
| Control E40 | 0 | 0 | 0 |
| E41 | 5000 | 5000 | 0 |
| E42 | 4000 | 4000 | 0 |
| E43 | 3000 | 3000 | 0 |
| E44 | 6000 | 0 | 1000 |
| E45 | 0 | 6000 | 1000 |
| E46 | 3000 | 3000 | 1000 |

Scraper plaster formulation E41 to E46 comprising the antimicrobial compositions according to table 2b were prepared, and aliquots of 50 ml of the scraper plaster were mixed with an aliquot of 800 μl (Mix-all), well mixed and incubated at room temperature for one week in the dark. After one week, 100 μl of a 1:10 dilution of PBS-buffer (Phosphate buffer saline 10 mM, pH 7.4, 137 mmol/l NaCl, 2.7 mmol/l KCl, 10 mmol/l Na₂HPO₄, 1.8 mmol/l KH₂PO₄) were plated out (100 colony forming units (cfu) per millilitre of paint) on standard TSA (Trypticase soy agar) plates, and incubated at 30° C. in a Binder 3.1 incubator. Samples were analysed after 48 h for growth of bacteria and after 72 h for growth of yeast/fungi/mould.

### Antimicrobial Activity Test in Dispersion Based Adhesive for Wooden Floor

Samples of the adhesive formulation were mixed with different amounts of water soluble or water dispersible source of bismuth ions, water soluble or water dispersible source of magnesium ions, water soluble or water dispersible source of sodium ions, water soluble or water dispersible source of potassium ions and water soluble or water dispersible source of zinc ions according to claim 1 as set out in Table 2c.

All amounts quoted in ppm correspond to mg values per kilogram of the corresponding ion based on the total weight of the adhesive formulation.

TABLE 2c

| Adhesive | | | | |
|---|---|---|---|---|
| formulation | Na₂CO₃ | K₂CO₃ | MgCO₃ | Bi₂O₃ |
| samples | ppm | ppm | ppm | ppm |
| Control E47 | 0 | 0 | 0 | 0 |
| E48 | 0 | 5000 | 1000 | 0 |
| E49 | 0 | 6000 | 1000 | 0 |
| E50 | 6000 | 0 | 1000 | 0 |
| E51 | 0 | 0 | 1000 | 9000 |
| E52 | 6000 | 2000 | 1000 | 0 |
| E53 | 5000 | 1000 | 0 | 0 |
| E54 | 3000 | 1000 | 0 | 0 |

Adhesive formulations E47 to E54 comprising the antimicrobial compositions according to table 2c were prepared, and aliquots of 50 ml of the adhesive were mixed with an aliquot of 800 μl (Mix-all), well mixed and incubated at room temperature for one week in the dark. After one week 100 μl of a 1:10 dilution of PBS-buffer (Phosphate buffer saline 10 mM, pH 7.4, 137 mmol/l NaCl, 2.7 mmol/l KCl, 10 mmol/l Na₂HPO₄, 1.8 mmol/l KH2PO4) were plated out (100 colony forming units (cfu) per millilitre of paint) on standard TSA (Trypticase soy agar) plates, and incubated at 30° C. in a Binder 3.1 incubator. Samples were analysed after 48 h for growth of bacteria and after 72 h for growth of yeast/fungi/mould.

### Antimicrobial Activity Test in Varnish

Samples of the varnish were mixed with different amounts of water soluble or water dispersible source of bismuth ions, water soluble or water dispersible source of magnesium ions, water soluble or water dispersible source of sodium ions, water soluble or water dispersible source of potassium ions and water soluble or water dispersible source of zinc ions according to claim 1 as set out in Table 2d.

All amounts quoted in ppm correspond to mg values per kilogram of the corresponding ion based on the total weight of the varnish formulation.

TABLE 2d

| Varnish | Na₂CO₃ | K₂CO₃ | MgCO₃ | Bi₂O₃ |
|---|---|---|---|---|
| samples | ppm | ppm | ppm | ppm |
| Control E55 | 0 | 0 | 0 | 0 |
| E56 | 0 | 5000 | 1000 | 0 |
| E57 | 0 | 6000 | 1000 | 0 |
| E58 | 5000 | 0 | 1000 | 0 |
| E59 | 6000 | 0 | 1000 | 0 |
| E60 | 6000 | 2000 | 1000 | 0 |
| E61 | 6000 | 2000 | 0 | 1000 |

Varnish formulation E55 to E61 comprising the antimicrobial compositions according to table 2d were prepared, and aliquots of 50 ml of the scraper plaster were mixed with an aliquot of 800 μl (Mix-all), well mixed and incubated at room temperature for one week in the dark. After one week, 100 μl of a 1:10 dilution of PBS-buffer (Phosphate buffer saline 10 mM, pH 7.4, 137 mmol/l NaCl, 2.7 mmol/l KCl, 10 mmol/l Na₂HPO₄, 1.8 mmol/l KH₂PO₄) were plated out (100 colony forming units (cfu) per millilitre of paint) on standard TSA (Trypticase soy agar) plates, and incubated at 30° C. in a Binder 3.1 incubator. Samples were analysed after 48 h for growth of bacteria and after 72 h for growth of yeast/fungi/mould.

### Bacteria/Yeast and Mould Counts of Antimicrobial Activity Tests and pH Values of Treated Base Paint and Commercial Latex Paint

When not otherwise indicated, the quoted bacterial/yeast and fungi counts are given as cfu/gram. In Table 3 hereto below the antimicrobial activity of the base paint formulations/commercial latex paint prepared according to table 2 are shown. The antimicrobial activity was weekly tested over a period of 10 weeks (W0 to W10), according to the microbial activity test in base paint mentioned above. Thus aliquots of the base paint formulations were taken over the 10 weeks and weekly tested with fresh bacteria/yeast and mould mixture mentioned above to evaluate the long term effect of the antimicrobial activity of the added antimicrobial compositions in a base paint formulation. In Table 4 hereto below the pH value at W0 and W10 of the base paint formulations prepared according to table 2 are shown.

### *: Legend:

All count numbers describes colony forming units per gram of product: cfu/g
t.c.: totally contaminated (>1×10⁸ cfu/g);
Limit of detection 100 cfu/g

TABLE 3

| | W0 | W1 | W2 | W3 | W4 | W5 | W6 | W7 | W8 | W9 | W10 |
|---|---|---|---|---|---|---|---|---|---|---|---|
| E1 | 300 | t.c. | t.c. | t.c. | t.c. | t.c. | t.c. | t.c. | t.c. | t.c. | t.c. |
| E2 | 300 | t.c. | t.c. | t.c. | t.c. | t.c. | t.c. | t.c. | t.c. | t.c. | t.c. |
| E3 | 300 | 15200 | <100 | 23200 | t.c. | t.c. | t.c. | t.c. | t.c. | t.c. | t.c. |
| E4 | 300 | t.c. | t.c. | t.c. | t.c. | t.c. | t.c. | t.c. | t.c. | t.c. | t.c. |
| E5 | 300 | <100 | <100 | <100 | <100 | 2000 | 800 | 11800 | t.c. | t.c. | t.c. |
| E6 | 300 | 200 | <100 | <100 | 1400 | <100 | 10000 | t.c. | <100 | t.c. | t.c. |
| E7 | 300 | <100 | <100 | <100 | <100 | <100 | <100 | <100 | <100 | 20700 | t.c. |
| E8 | <100 | t.c. | t.c. | t.c. | t.c. | t.c. | t.c. | t.c. | t.c. | t.c. | t.c. |
| E9 | <100 | <100 | <100 | t.c. | t.c. | t.c. | t.c. | t.c. | t.c. | t.c. | t.c. |
| E10 | <100 | <100 | t.c. | t.c. | t.c. | t.c. | t.c. | t.c. | t.c. | t.c. | t.c. |
| E11 | <100 | <100 | <100 | <100 | <100 | <100 | 3700 | 30900 | t.c. | t.c. | t.c. |
| E12 | <100 | <100 | <100 | 1700 | t.c. | t.c. | t.c. | t.c. | t.c. | t.c. | t.c. |
| E13 | <100 | t.c. | t.c. | t.c. | t.c. | t.c. | t.c. | t.c. | t.c. | t.c. | t.c. |
| E14 | <100 | <100 | <100 | <100 | <100 | <100 | <100 | <100 | <100 | <100 | <100 |
| E15 | <100 | <100 | <100 | <100 | <100 | <100 | <100 | <100 | <100 | <100 | <100 |
| E16 | <100 | <100 | <100 | <100 | <100 | <100 | <100 | <100 | <100 | <100 | <100 |
| E17 | <100 | <100 | <100 | <100 | <100 | <100 | <100 | <100 | <100 | <100 | <100 |
| E18 | <100 | <100 | t.c. | t.c. | t.c. | t.c. | t.c. | t.c. | t.c. | t.c. | t.c. |
| E19 | <100 | <100 | <100 | <100 | <100 | <100 | <100 | <100 | <100 | <100 | 0 |
| E20 | <100 | <100 | <100 | <100 | t.c. | t.c. | 2400 | t.c. | t.c. | t.c. | t.c. |
| E21 | <100 | t.c. | t.c. | t.c. | t.c. | | | | | | |
| E22 | <100 | <100 | <100 | <100 | <100 | | | | | | |
| E23 | <100 | <100 | 200 | 8500 | t.c. | | | | | | |
| E24 | <100 | <100 | <100 | 1600 | 3500 | | | | | | |
| E25 | <100 | <100 | <100 | <100 | <100 | | | | | | |
| E26 | <100 | <100 | <100 | 3200 | 1200 | | | | | | |
| E27 | <100 | <100 | <100 | 200 | t.c. | | | | | | |
| E28 | 1100 | 100000 | 100000 | | | | | | | | |
| E29 | 100 | 100 | 100 | | | | | | | | |
| E30 | 100 | 100 | 100 | | | | | | | | |
| E31 | 100 | 100 | 100 | | | | | | | | |
| E32 | 100 | 100 | 100 | | | | | | | | |
| E33 | 100 | 100 | 100 | | | | | | | | |
| E34 | 100000 | 100000 | 100000 | | | | | | | | |
| E35 | 100 | 100 | 100 | | | | | | | | |
| E36 | 100 | 100 | 100 | | | | | | | | |
| E37 | 100 | 100 | 100 | | | | | | | | |
| E38 | 100 | 100 | 100 | | | | | | | | |
| E39 | 100 | 100 | 200 | | | | | | | | |

TABLE 4

| | E1 | E2 | E3 | E4 | E5 | E6 | E7 |
|---|---|---|---|---|---|---|---|
| pH W0 | 7.90 | 8.34 | 10.06 | 9.18 | 10.12 | 10.28 | 9.34 |
| pH W10 | 7.49 | 8.34 | 8.83 | 7.81 | 8.91 | 9.54 | 8.12 |
| | E8 | E9 | E10 | E11 | E12 | E13 | E14 |
| pH W0 | 8.34 | 9.92 | 9.84 | 10.10 | 10.10 | 8.81 | 9.98 |
| pH W10 | 7.65 | 8.55 | 8.16 | 9.13 | 9.39 | 7.6 | 9.82 |
| | E15 | E16 | E17 | E18 | E19 | E20 | |
| pH W0 | 10.23 | 10.07 | 10.19 | 9.2 | 10.42 | 10.21 | |
| pH W10 | 9.97 | 9.89 | 9.98 | 8.16 | 9.81 | 8.65 | |
| | E21 | E22 | E23 | E24 | E25 | E26 | E27 |
| pH W0 | 8.95 | 10.18 | 10.35 | 10.28 | 10.40 | 10.13 | 10.58 |
| | E28 | E29 | E30 | E31 | E32 | E33 | |
| pH W0 | 8.22 | 9.83 | 9.96 | 9.76 | 8.69 | 9.86 | |
| pH W2 | 7.84 | 9.57 | 9.31 | 9.22 | 9.34 | 9.15 | |
| | E34 | E35 | E36 | E37 | E38 | E39 | |
| pH W0 | 8.28 | 10.27 | 9.87 | 10.25 | 10.12 | 10.10 | |
| pH W2 | 8.06 | 9.67 | 9.59 | 9.47 | 8.56 | 8.19 | |

### Bacteria/Yeast and Mould Counts of Antimicrobial Activity Tests and pH Values of Treated Scraper Plaster

When not otherwise indicated, the quoted bacterial/yeast and fungi counts are given as cfu/gram. In Table 5 hereto below the antimicrobial activity of the scraper plaster prepared according to table 2b are shown. The antimicrobial activity was weekly tested over a period of 6 weeks (W0 to W6), according to the microbial activity test in base paint mentioned above. Thus aliquots of the base paint formulations were taken over the 6 weeks and weekly tested with fresh bacteria/yeast and mould mixture mentioned above to evaluate the long term effect of the antimicrobial activity of the added antimicrobial compositions in a scraper plaster formulation. In Table 6 hereto below the pH value at W0 and W6 of the scraper plaster formulations prepared according to table 2b are shown.

### *: Legend:

All count numbers describes colony forming units per gram of product: cfu/g
t.c.: totally contaminated (>1×10⁸ cfu/g);
Limit of detection 100 cfu/g

TABLE 5

| | W0 | W1 | W2 | W3 | W4 | W5 | W6 |
|---|---|---|---|---|---|---|---|
| E40 | <100 | <100 | t.c. | t.c. | t.c. | t.c. | t.c. |
| E41 | <100 | <100 | <100 | <100 | <100 | <100 | <100 |
| E42 | <100 | <100 | <100 | <100 | <100 | <100 | <100 |
| E43 | <100 | <100 | <100 | <100 | <100 | <100 | <100 |
| E44 | <100 | <100 | <100 | <100 | <100 | <100 | <100 |
| E45 | <100 | <100 | <100 | <100 | <100 | <100 | <100 |
| E46 | <100 | <100 | <100 | <100 | <100 | <100 | <100 |

TABLE 6

| | E40 | E41 | E42 | E43 | E44 | E45 | E46 |
|---|---|---|---|---|---|---|---|
| pH_W0 | 8.59 | 10.93 | 10.61 | 10.60 | 10.71 | 10.51 | 10.63 |
| pH_W6 | 7.67 | 10.37 | 10.3 | 10.1 | 10.09 | 10.06 | 9.97 |

### Bacteria/Yeast and Mould Counts of Antimicrobial Activity Tests and pH Values of Treated Adhesive

When not otherwise indicated, the quoted bacterial/yeast and fungi counts are given as cfu/gram. In Table 7 hereto below the antimicrobial activity of adhesive prepared according to table 2c are shown. The antimicrobial activity was weekly tested over a period of 2 weeks (W0 to W2), according to the microbial activity test in the adhesive mentioned above. Thus aliquots of the adhesive formulations were taken over the 2 weeks and weekly tested with fresh bacteria/yeast and mould mixture mentioned above to evaluate the long term effect of the antimicrobial activity of the added antimicrobial compositions in adhesive formulation. In Table 8 hereto below the pH value at W0 and W2 of the adhesive formulations prepared according to table 2c are shown.

### *: Legend:

All count numbers describes colony forming units per gram of product: cfu/g
t.c.: totally contaminated (>1×10⁸ cfu/g);
Limit of detection 100 cfu/g

TABLE 7

| | W 0 | W 1 | W 2 |
|---|---|---|---|
| E47 | <100 | t.c. | t.c. |
| E48 | <100 | <100 | <100 |
| E49 | <100 | <100 | <100 |
| E50 | <100 | <100 | <100 |
| E51 | <100 | <100 | <100 |
| E52 | <100 | <100 | <100 |
| E53 | <100 | <100 | <100 |
| E54 | <100 | <100 | <100 |

TABLE 8

| | E47 | E48 | E49 | E50 | E51 | E52 | E53 | E54 |
|---|---|---|---|---|---|---|---|---|
| pH_W0 | 7.55 | 9.36 | 9.24 | 9.34 | 8.06 | 9.34 | 9.28 | 8.75 |
| pH_W2 | n/a | n/a | n/a | n/a | n/a | n/a | n/a | n/a |

### Bacteria/Yeast and Mould Counts of Antimicrobial Activity Tests and pH Values of Treated Varnish

When not otherwise indicated, the quoted bacterial/yeast and fungi counts are given as cfu/gram. In Table 9 hereto below the antimicrobial activity of varnish prepared according to table 2d are shown. The antimicrobial activity was weekly tested over a period of 3 weeks (W0 to W3), according to the microbial activity test in the adhesive mentioned above. Thus aliquots of the adhesive formulations were taken over the 3 weeks and weekly tested with fresh bacteria/yeast and mould mixture mentioned above to evaluate the long term effect of the antimicrobial activity of the added antimicrobial compositions in adhesive formulation. In Table 10 hereto below the pH value at W0 and W3 of the varnish formulations prepared according to table 2d are shown.

### *: Legend:

All count numbers describes colony forming units per gram of product: cfu/g
t.c.: totally contaminated (>1×10⁸ cfu/g);
Limit of detection 100 cfu/g

TABLE 9

| | W 0 | W 1 | W 2 | W 3 |
|---|---|---|---|---|
| Control E55 | <100 | t.c. | t.c. | t.c. |
| E56 | <100 | 4900 | t.c. | t.c. |
| E57 | <100 | 11100 | t.c. | t.c. |
| E58 | <100 | 10600 | t.c. | t.c. |
| E59 | <100 | t.c. | 24400 | t.c. |
| E60 | <100 | 42500 | 1300 | t.c. |
| E61 | <100 | <100 | 20400 | t.c. |

TABLE 10

| | Control | | | | | | |
|---|---|---|---|---|---|---|---|
| | E55 | E56 | E57 | E58 | E59 | E60 | E61 |
| pH_W0 | 8.43 | 8.89 | 9.47 | 9.47 | 9.38 | 9.27 | 9.14 |
| pH_W3 | 8.14 | 9.09 | 9.13 | 9.18 | 9.39 | 9.60 | 9.62 |

From the data of Table 3, it can be seen that the use of at least one water soluble or water dispersible source of zinc ion (ZnO) alone (E3) is not able to stabilize the base formulation over 4 weeks. Contrary to that, the combination of at least one water soluble or water dispersible source of zinc ion (ZnO) with at least one water soluble or water dispersible source of magnesium ions and/or at least one water soluble or water dispersible source of sodium ions (E6, E7) shows that the base formulation can be stabilized for at least 7 weeks.

From examples 9 to 12, 14 to 17, 19, 20 and 22 to 26 it can be seen that a storage stabilization agent for stabilizing an aqueous composition upon storage according to the present invention, namely comprising at least two different water soluble or water dispersible ion sources selected from the group consisting of water soluble or water dispersible source of bismuth ions, water soluble or water dispersible source of magnesium ions, water soluble or water dispersible source of sodium ions, water soluble or water dispersible source of potassium ions and water soluble or water dispersible source of zinc ions can stabilize the base paint upon storage in that it does not exhibit a change in the pH value of more than ±2 and/or does prevent or reduce the growth and/or reproduction of microorganisms, viruses and/or bacteriophages for at least 15 days.

Therefore, the use of the inventive storage stabilization agent stabilizes the aqueous composition upon storage, especially the aqueous preparation is stabilized for a defined amount of time against microorganisms, viruses and/or bacteriophages and especially against bacterial/yeast and fungi growth.

1. Storage stabilization agent for stabilizing an aqueous composition upon storage comprising at least two different water soluble or water dispersible ion sources selected from the group consisting of water soluble or water dispersible source of bismuth ions, water soluble or water dispersible source of magnesium ions, water soluble or water dispersible source of sodium ions, water soluble or water dispersible source of potassium ions and water soluble or water dispersible source of zinc ions.

2. The storage stabilization agent according to claim 1, wherein the water soluble or water dispersible source of bismuth ions is at least one bismuth salt.

3. The storage stabilization agent according to claim 1, wherein the water soluble or water dispersible source of magnesium ions is at least one magnesium salt.

4. The storage stabilization agent according to claim 1, wherein the water soluble or water dispersible source of sodium ions is at least one sodium salt.

5. The storage stabilization agent according to claim 1, wherein the water soluble or water dispersible source of zine ions is at least one zinc salt.

6. The storage stabilization agent according to claim 1, wherein the water soluble or water dispersible source of potassium ions is at least one potassium salt.

7. The storage stabilization agent according to claim 1, wherein the storage stabilization agent comprises water.

8. The storage stabilization agent according to claim 7, wherein the storage stabilization agent has a pH value in the range from 3 to 14.

9. The storage stabilization agent according to claim 1, wherein the weight ratio of the at least two different water soluble or water dispersible ion sources is from 100:1 to 1:100.

10. The storage stabilization agent according to claim 1, wherein the storage stabilization agent is free of at least one water soluble or water dispersible source of lithium ions.

11. The storage stabilization agent according to claim 1, wherein the storage stabilization agent comprises further additives selected from the group consisting of dispersing agents, viscosity agents, thickeners, rheological additives and defoaming agents.

12. The storage stabilization agent according to claim 1, wherein the at least two different water soluble or water dispersible ion sources are
(i) a water soluble or water dispersible source of bismuth ions in combination with a water soluble or water dispersible source of magnesium ions or a water soluble or water dispersible source of sodium ions or
(ii) a water soluble or water dispersible source of sodium ions in combination with a water soluble or water dispersible source of zinc ions.

13. Aqueous preparation comprising the storage stabilization agent according to claim 1.

14. The aqueous preparation according to claim 13, wherein the storage stabilization agent is present in an amount such that the pH value of the aqueous preparation is stabilized and the aqueous preparation is preserved against microorganisms, viruses and/or bacteriophages for at least 15 days.

15. The aqueous preparation according to claim 13, wherein the aqueous preparation further comprises
(i) at least one inorganic particulate material, and/or
(ii) at least one organic material.

16. The aqueous preparation according to claim 13, wherein the aqueous preparation has
(i) a pH value of from 3 to 14, and/or
(ii) a solids content of up to 85.0 wt.-%, based on the total weight of the aqueous preparation.

17. Process for stabilizing an aqueous preparation upon storage, said process comprises the steps of
a) providing an aqueous preparation,
b) providing a storage stabilization agent as defined in claim 1, and
c) contacting and mixing the aqueous preparation of step a) with the storage stabilization agent of step b) in any order for obtaining the stabilized aqueous preparation.

18. The process of claim 17, wherein the process provides for stabilizing the pH value of the aqueous preparation and/or for preserving the aqueous preparation against microorganisms, viruses and/or bacteriophages.

19. The process according to claim 17, wherein the aqueous preparation is a paper making formulation, a paper coating formulation, fibre formulation, food formulation, pharmaceutical formulation, cosmetic formulation, plastic formulation, plaster formulation, varnish formulation, joint filler formulation, adhesive formulation, metal working fluid, cooling fluid, primer coat, levelling compound, and/or a paint formulation.

20. The process according to claim 18, wherein the microorganisms are selected from the group comprising at least one strain of bacteria, at least one strain of fungi, mold, yeast, algae and mixtures thereof.
